(19) United States
(12) Patent Application Publication
(10) Pub. No.: US 2013/0144566 A1
(43) Pub. Date: Jun. 6, 2013

(54) REAL-TIME COLLABORATIVE DESIGN PLATFORM

(71) Applicant: Kaustuv Kanti De Biswas, San Francisco, CA (US)

(72) Inventor: Kaustuv Kanti De Biswas, San Francisco, CA (US)

(73) Assignee: DESIGN PLAY TECHNOLOGIES INC., Palo Alto, CA (US)

(21) Appl. No.: 13/565,426

(22) Filed: Aug. 2, 2012

Related U.S. Application Data
(60) Provisional application No. 61/514,222, filed on Aug. 2, 2011.
(60) Provisional application No. 61/661,200, filed on Jun. 18, 2012.

(51) Int. Cl. G06F 17/50

(52) U.S. Cl. CPC G06F 17/50
USPC 703/1

(57) ABSTRACT

A real-time collaborative design platform provides a hierarchical 3D model space as a plurality of nodes and branches. Each node may include at least one version of a sub-component and each version may include one or more attributes. The platform facilitates selecting a hierarchical tree from the 3D model space based, at least in part, upon at least one of the one or more attributes associated with sub-components. The platform also facilitates making the 3D model space accessible by multiple users over a network, such as the Internet. Also, each version of a sub-component is accessible in a library associated with the 3D model space.

### CROSS-REFERENCE TO RELATED APPLICATIONS

This application claims the benefit of the following U.S. provisional patent applications: U.S. Ser. No. 61/514,222 filed Aug. 2, 2011, and U.S. Ser. No. 61/661,200 filed Jun. 18, 2012.

### BACKGROUND

1. Field:

This disclosure relates to a system and methods for enabling real-time collaboration in 3D modeling and simulation.

2. Description of the Related Art

Three-dimensional modeling systems offer basic multi-user capabilities yet fall short of full multi-user collaborative design, distributed version control, democratized application access and sharing, and the like.

### SUMMARY OF THE INVENTION

In accordance with exemplary and non-limiting embodiments, a platform comprising a real-time design tool agnostic collaborative design platform is disclosed that enables multiple users to interact on a project by project basis in the collaborative design, modeling and testing of complex 3-Dimensional, or “3D”, models while maintaining version control of all elements of the project in a hierarchical fashion. As described more fully below, version control may be distributed to a variety of users and enforceable throughout the modeling space without being dependent on an environment in which each model/part is edited/changed.

Specifically, the component elements of a project may be arranged in a tree-like hierarchical fashion wherein, at each node, branches sub-divide into increasingly atomic sub-components. Each such sub-component may itself be sub-divided into increasingly granular sub-components, and so on. In addition, each node may be comprised of several versions of the same component or sub-component. As a result, the branches of a tree forming a component may be traversed in a multiplicity of ways depending on which version of a sub-component is selected for inclusion when forming the overall component.

As described in accordance with various exemplary and non-limiting embodiments, different versions of sub-components may be selected for inclusion in forming the component based on various factors. For example, versions of sub-components may be tagged with attributes such as price, cost, license status/clearance, strength, stress/strain, weight, material properties, geometry and the like. Some attributes such as, for example, price, may be entered by a user while other attributes such as, for example, geometry, may be computed by the platform. Using these attributes, branches and/or versions of a component may be selected based, for example, upon business rules and constraints, performance criteria, compatibility rules, compatibility based on geometry and the like.

In accordance with various other exemplary and non-limiting embodiments, there is provided a methodology for providing a user interface via which a plurality of users may simultaneously share a 3D model. Because 3D models may include numerous sub-components each comprising a considerable amount of data, it is not always preferable to transmit all of the data comprising a component, a sub-component and/or various versions thereof. Therefore, in some embodiments, data is accessed and provided to users, such as via a user interface, on an “as needed” basis. For example, data may be provided on a point of view proximity basis. Specifically, data may be provided for only those elements and/or subcomponents that are visible within a view of the component on a user interface such as might occur when displaying a perspective rendering of the component. In addition, the amount of detail embodied in provided data may be altered or culled based on a level of zoom at which a model or part of a model is viewed. Such “as needed” and view proximity techniques may be applied to the entire 3D space, a portion of the space (e.g. a sub-space), an assembly of components, a plurality of components, and the like. In an example, if a user is viewing a 3D representation of a room with solid walls, the surfaces of the walls that are visible from the user's view point may be provided with resolution that is appropriate for the view proximity and inner structure of the wall may not be provided. Likewise, if a user is viewing the room and there is a window in the wall that is in the user's view, items outside the window may be culled or provided with lower fidelity than items hanging on the wall next to the window based on view proximity.

In accordance with various other exemplary and non-limiting embodiments, there is provided a methodology for sharing 3D modeling sub-spaces amongst multiple users. Specifically, sub-spaces comprising one or more sub-components may be established and distributed amongst multiple users. Once divided, sub-spaces may be subsequently recombined to create an integrated assembly of sub-components in 3D modeling space. In accordance with exemplary embodiments, users may be assigned to a sub-space and data defining a sub-space may be communicated to a user for use with one or more software modeling tools of the user's choosing. Because various modeling tools make use of disparate data formats, the platform may translate stored 3D model data into the desired format of a requesting user in preparation for transmission. The user may then alter the data so provided and communicate it, perhaps as an updated version, back to the platform for subsequent storage. Upon receiving such data back from a user, the platform once again may translate the data so received from its data format of origin into a data format or data formats compatible and/or consistent with the 3D model data stored within or accessible to the platform. Alternatively, translation to/from a desired format may occur at a computing facility that is local to the user's desired design tool so that data is transmitted in a format that is consistent with the 3D model data accessible to the platform. Likewise, translation may occur at an intermediate facility so that data transmitted between a user's design tool and the intermediate facility is in the design tool original format and data transmitted between the intermediate facility and the

In accordance with various other exemplary and non-limiting embodiments, there is provided a methodology for supporting an Application, or “App” store. Specifically, the platform may support the provision of various applications, such as on a pay per use basis, to users for interacting with 3D data models to which a user or users have access. For example, a group of collaborative users with access to a design for an aircraft wing may wish to perform analysis of stress on the wing under defined circumstances. In such an instance, the users may select an app, such as from an app store, to perform such specific analysis.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The each version may include one or more attributes. The method may further include selecting a hierarchical tree from the 3D model space. The 3D model space may include a plurality of the plurality of nodes and at least one of the at least one branch. The each of the plurality of the plurality of nodes may include a single version of a sub-component selected, based, at least in part, upon at least one of the one or more attributes associated with the sub-component. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The each version may include one or more attributes. The method may further include selecting a hierarchical tree from the 3D model space. The 3D model space may include a plurality of nodes of at least one branch. The each node may include a single version of a sub-component selected based at least in part, upon a predefined fit criteria of the sub-component. The fit criteria may be a price of the sub-component. The fit criteria may be a price of an assembly that may include the sub-component. The fit criteria may be determined from a business rule associated with the 3D model space. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a hierarchical 3D model space. The hierarchical 3D model space may include a branch. Each node may include at least one version of a sub-component. The each version may include one or more attributes. The method may further include selecting a hierarchical tree from the 3D model space. The 3D model space may include at least one branch. Each node may include a single version of a sub-component selected based at least in part upon a predefined performance criteria of the sub-component. The performance criteria may be a measure of strength of the sub-component. The performance criteria may be a measure of stress/strain tolerance of the sub-component. The performance criteria may be a measure of weight of the sub-component. The performance criteria may be an aspect of material properties of the sub-component. The performance criteria may be based on compatibility of the sub-component with other sub-components in the 3D model space. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The each of the at least one version may include one or more attributes. The method may further include selecting a hierarchical tree from the 3D model space. The 3D model space may include at least one branch. Each of the nodes may include a single version of a sub-component selected based at least in part upon compatibility of the sub-component. The compatibility may include compatibility of the sub-component with mating sub-components in the 3D model space. The compatibility may include geometric compatibility. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The each of the at least one version may include one or more attributes. The method may further include presenting to a user a representation of each of the at least one version of a sub-component for selecting one of the at least one version of the sub-component. The method may further include, in response to the selecting one of the at least one version of the sub-component, rendering the sub-component identified by the selected one of the at least one version of the sub-component in the 3D model space. The rendering of the sub-component may include disposing the sub-component in an assembly of sub-components. The way of presenting the representation of each of the at least one version of a sub-component may include presenting a low-resolution version of the sub-component that includes a visual indication of changes associated with the at least one version. A plurality of low-resolution versions of the sub-component may be presented along a time line of versions of the sub-component. A resolution of the low-resolution version may be based, at least in part, upon a viewing direction from which the sub-component may be viewed. A resolution of the low-resolution version may be based, at least in part, upon a viewing location from which the sub-component may be viewed. The way of presenting the representation of each of the at least one version of a sub-component may include presenting a timeline of changes to the sub-component and selecting a position along the timeline results in selecting one of the at least one version of the sub-component. The way of presenting the representation of each of the at least one version of a sub-component may include presenting a subset of versions of the sub-component based on a predefined criteria for the one or more attributes. The predefined criteria may be a cost of the sub-component. The cost may be based, at least in part, upon a factor selected from the group that may include material costs, fabrication costs, warranty costs and maintenance costs. The predefined criteria may be a material type of the sub-component. The predefined criteria may be a lead-time to acquire the sub-component. The predefined criteria may be an outcome of an automated analysis of the sub-component. The predefined criteria may be strength of the sub-component. The performance criteria may be a measure of stress/strain tolerance of the sub-component. The performance criteria may be a measure of weight of the sub-component. The performance criteria may be an aspect of material properties of the sub-component. The performance criteria may be based on compatibility of the sub-component with other sub-components in the 3D model space. The at least one of the one or more attributes associated with the sub-component may be a visual appearance of the sub-component and the way of selecting may include selecting the hierarchical tree based, at least in part, upon the visual appearance. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a hierarchical 3D model space. The hierarchical 3D model space may include a plurality of nodes and at least one branch. The each node may include a plurality of versions of a sub-component. The each of the plurality of versions may include one or more component attributes. The method may further include receiving sub-component selection criteria with an automated version selection facility. The method may also include comparing at least one of the one or more component attributes for each of the plurality of versions of the sub-component to determine at least one version of the plurality of versions that satisfies the sub-component selection criteria. The method may further include configuring the hierarchical 3D model space with at least one of the versions that satisfies the sub-component selection criteria. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The each of the at least one version may include one or more attributes. The method may further include receiving from a user a selection of at least one attribute identifier. The method may also include selecting a version of a sub-component based, at least in part, upon the at least one attribute identifier. The method may further include, in response to the selecting one of the at least one version of the sub-component, rendering the sub-component identified by the selected one of the version of the sub-component in the 3D model space. The method may further include determining if the selected sub-component may be compatible with other sub-components in the 3D model space. The method may also include presenting an error indicator to the user if the selected sub-component may not be compatible with other sub-components in the 3D model space. The 3D model space may be accessible by multiple users over a network. The network may be the Internet. The each version of a sub-component may be accessible in a library associated with the 3D model space. The at least one attribute identifier may be a fit criteria. The fit criteria may be a price of the sub-component. The fit criteria may be a price of an assembly that may include the sub-component. The fit criteria may be determined from a business rule associated with the 3D model space. The at least one attribute identifier may be a performance criteria. The performance criteria may be a measure of strength of the sub-component. The performance criteria may be a measure of stress/strain tolerance of the sub-component. The performance criteria may be a measure of weight of the sub-component. The performance criteria may be an aspect of material properties of the sub-component. The performance criteria may be based on compatibility of the sub-component with other sub-components in the 3D model space. The at least one attribute identifier may identify a compatibility of the sub-component with mating sub-components in the 3D model space. The compatibility may include geometric compatibility. The way of rendering further includes rendering a first identifier of the sub-component identified by the selected one of the version of the sub-component in the 3D model space and a second identifier of at least one other not selected sub-component wherein the first identifier may be graphically highlighted. The graphical highlighting may include color. The graphical highlighting may include underlining. The graphical highlighting may include outlining. The error indicator may be an error message.

In accordance with exemplary and non-limiting embodiments, the present disclosure provides a method that may include providing a hierarchical 3D model space. The hierarchical 3D model space may include a first node and a second node. The each of the first and second nodes may include at least one version of a sub-component. The each of the at least one version may include one or more attributes. The method may further include providing a first user administrative control of version selection for sub-components of the first node. The method may also include providing a second user administrative control of version selection for sub-components of the second node. A third user may be provided administrative control of version selection of the 3D model space. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The each of the at least one version may include one or more attributes. The method may further include transmitting a first version of a sub-component to a user. The method may also include receiving from the user a second version of the sub-component that may include an updated version of the first version. The method may further include storing the second version of the sub-component in the 3D model space associated with the same node as the first version of the sub-component. The method may also include translating a data format of the first version of the sub-component from a source data format to a target data format, prior to transmitting. The method may further include translating a data format of the second version of the sub-component from the target data format to the source data format, upon receiving. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a distributed hierarchical 3D model space. The distributed hierarchical 3D model space may include a plurality of nodes and at least one branch. The each node may include at least one version of a sub-component. The each of the at least one version may include one or more attributes. The method may also include selecting a hierarchical tree from the distributed 3D model space. The distributed 3D model space may include at least one branch. The each node may include a single version of a sub-component selected, based, at least in part, upon at least one of the attributes associated with the sub-component. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The each of the at least one version may include one or more attributes. The method may further include maintaining at a terminus of at least one branch a node that may include a plurality of versions of a sub-component. The plurality of versions may include a first version of a sub-component having a first value of an attribute and a second version of a sub-component having a second value of the attribute. The first value may be different than the second value. The attribute may be a fit criterion. The fit criteria may be a price of the sub-component. The fit criteria may be a price of an assembly that may include the sub-component. The fit criteria may be determined from a business rule associated with the 3D model space. The attribute may be a performance criterion. The performance criteria may be a measure of strength of the sub-component. The performance criteria may be a measure of stress/strain tolerance of the sub-component. The performance criteria may be a measure of weight of the sub-component. The performance criteria may be an aspect of material properties of the sub-component. The performance criteria may be based on compatibility of the sub-component with other sub-components in the 3D model space. The attribute identifies a compatibility of the sub-component with mating sub-components in the 3D model space. The compatibility may include geometric compatibility. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a distributed hierarchical 3D model space for collaboration among a plurality of users. The model space may include a plurality of nodes. The at least one node may be at a lower level in a hierarchy than at least one other node. The each node may include at least one version of a sub-component. The method may further include facilitating selection of a version of a sub-component associated with the lower level node. The selected version of the sub-component associated with the lower level may be integrated with one or more versions of a sub-component of the other node in the 3D model space. The at least one node and the at least one other node may be configured in a three dimensional sub-space of the 3D model space. The sub-component associated with the at least one other node may be accessible in a first sub-space of the 3D model space. The sub-component associated with the lower level may be accessible in a three-dimensional sub-space of the first sub-space. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The each of the at least one version may include one or more attributes. The method may further include identifying a sub-space of the hierarchical 3D model space that may include a first version of a sub-component to a user. The method may also include transmitting the first version of a sub-component to a user. The method may further include receiving from the user a second version of the sub-component that may include an updated version of the first version. The method may also include storing the second version of the sub-component in the 3D model space associated with the same node as the first version of the sub-component. The 3D model space may be accessible by multiple users over a network. The network may be the Internet. The each version of a sub-component may be accessible in a library associated with the 3D model space. The method may further include translating a data format of the first version of the sub-component from a source data format to a target data format, prior to transmitting. The method may also include translating a data format of the second version of the sub-component from the target data format to the source data format, upon receiving. The method may further include verifying a permission of the user to access the sub-space.

In accordance with exemplary and non-limiting embodiments, the present disclosure provides a system that may include a collaborative 3D model space configured for collaborative design by a plurality of users distributed over a network. Components accessible in the 3D model space may be concurrently accessible to the plurality of users. The system may further include an interface port of the 3D model space for providing access to at least one component so that each of the plurality of users can individually manipulate a three-dimensional view of the at least one component on disparate client computers. The disparate client computers may include at least two of a mobile phone, a tablet, a laptop, smart phone, notebook, desktop, and a workstation. The network may be the Internet. A plurality of versions of a component may be accessible in a library associated with the 3D model space.

In accordance with exemplary and non-limiting embodiments, the present disclosure provides a system that may include a collaborative 3D model space configured for collaborative design by a plurality of users distributed over a network. Components accessible in the 3D model space may be stored in a common format. The system may further include an interface port of the 3D model space for receiving requests from a plurality of client computers over the network for user access to components in the 3D model space and for converting the component from the common format to separate formats that may be suitable for representing at least two dimensions of the 3D model space in an electronic display of each of a plurality of types of client computers. The 3D model space may be accessible by multiple users over a network. The network may be the Internet. Each version of a sub-component may be accessible in a library associated with the 3D model space. Disparate client computers may be selected from the group consisting of a mobile phone, a tablet, a laptop, smart phone, notebook, desktop and a workstation.

In accordance with exemplary and non-limiting embodiments, the present disclosure provides a method that may include receiving a request via a first user interface for a sub-space of a hierarchical 3D model space that may include a plurality of nodes and at least one branch. The each node may include at least one version of a sub-component. The method may further include retrieving a portion of the sub-space. The method may also include transmitting the portion of the sub-space to the first user interface. The method may further include transmitting to the first user interface information indicative of a use of the sub-space via a second user interface. The 3D model space may be accessible by multiple users over a network. The network may be the Internet. The each version of a sub-component may be accessible in a library associated with the 3D model space. The first user interface and the second user interface communicate to perform collaborative design of the sub-space. The first interface and the second interface communicate synchronously. The first interface and the second interface communicate asynchronously.

In accordance with exemplary and non-limiting embodiments, the present disclosure provides a method that may include receiving a request via a user interface for a sub-space of a hierarchical 3D model space. The hierarchical 3D model space may include a plurality of nodes and at least one branch. The each node may include at least one version of a sub-component the request that may include a viewing location. The method may further include retrieving a portion of the sub-space based, at least in part, upon the viewing location. The method may also include transmitting the portion of the sub-space to the user interface. The method may further include reducing a resolution of the at least one sub-component of the retrieved portion of the sub-space. The 3D model space may be accessible by multiple users over a network. The network may be the Internet. The each version of a sub-component may be accessible in a library associated with the 3D model space. The viewing location may include x,y,z coordinates corresponding to the 3D model space. The way of reducing may include culling a number of triangles defining the at least one sub-component of the retrieved portion of the sub-space. The reducing may include reducing the resolution of the at least one sub-component of the retrieved portion of the sub-space based, at least in part, upon a screen resolution of the user interface.

In accordance with exemplary and non-limiting embodiments, the present disclosure provides a method that may include receiving a request via a user interface for a sub-space of a hierarchical 3D model space. The hierarchical 3D model space may include a plurality of nodes and at least one branch. The each node may include at least one version of a sub-component the request that may include a viewing direction. The method may further include retrieving a portion of the sub-space based, at least in part, upon the viewing direction. The method may also include transmitting the portion of the sub-space to the user interface. The 3D model space may be accessible by multiple users over a network. The network may be the Internet. The each version of a sub-component may be accessible in a library associated with the 3D model space. The viewing direction may include a vector direction corresponding to the 3D model space. The method may further include reducing a resolution of the at least one sub-component of the retrieved portion of the sub-space. The way of reducing may include culling a number of triangles defining the at least one sub-component of the retrieved portion of the sub-space. The way of reducing may include reducing the resolution of the at least one sub-component of the retrieved portion of the sub-space based, at least in part, upon a screen resolution of the user interface.

In accordance with exemplary and non-limiting embodiments, the present disclosure provides a method that may include receiving a request via a user interface for a sub-space of a hierarchical 3D model space. The hierarchical 3D model space may include a plurality of nodes and at least one branch. The each node may include at least one version of a sub-component the request that may include a viewing direction and a viewing location. The method may further include retrieving a portion of the sub-space based, at least in part, upon the viewing direction and viewing location. The method may also include transmitting the portion of the sub-space to the user interface. The 3D model space may be accessible by multiple users over a network. The network may be the Internet. The each version of a sub-component may be accessible in a library associated with the 3D model space. The retrieving of the portion of the sub-space may include at least one reduced resolution version of at least one sub-component.

In accordance with exemplary and non-limiting embodiments, the present disclosure provides a system that may include a 3D modeling space accessible over a network by a plurality of client computers. The 3D modeling space may include at least one sub-space for multi-user 3D design collaboration. The system may further include a sub-space specification that identifies an extent of the sub-space in three dimensions relative to the 3D modeling space. The system may also include a design component accessible in the sub-space by software executing on a portion of the plurality of client computers. The system may further include a component access facility for encoding the design component into a plurality of formats that may be compatible with the software executing on the portion of the plurality of client computers. The 3D modeling space may be accessible by multiple users over a network. The network may be the Internet. Each version of a component may be accessible in a library associated with the 3D modeling space.

In accordance with exemplary and non-limiting embodiments, the present disclosure provides a method that may include receiving a request from at least one of a plurality of users each having access a sub-space of a hierarchical 3D model space. The hierarchical 3D model space may include a plurality of nodes and at least one branch. The each node may include at least one version of a sub-component. The method may further include retrieving the sub-space. The method may also include transmitting the sub-space to the at least one of the plurality of users. The 3D model space may be accessible by multiple users over a network. The network may be the Internet. The each version of a sub-component may be accessible in a library associated with the 3D model space. The method may also include receiving from one of the plurality of users an updated sub-component forming a part of the sub-space. The method may further include transmitting the updated sub-component to the at least one of the plurality of users.

In accordance with exemplary and non-limiting embodiments, the present disclosure provides a system that may include a 3D modeling space accessible over a network by a plurality of client computers. The 3D modeling space may include at least one sub-space for multi-user 3D design collaboration. The system may further include a sub-space specification that identifies an extent of the sub-space in three dimensions relative to the 3D modeling space. The system may also include a second sub-space specification that identifies an extent of a second sub-space in three dimensions relative to the sub-space specification. The sub-space and the second sub-space may include a hierarchy of sub-spaces. The network may be the Internet. A library of sub-components that may be accessible in at least one of the first and second sub-spaces may be associated with the 3D model space.

In accordance with exemplary and non-limiting embodiments, the present disclosure provides a method that may include receiving a request from at least one of a plurality of users each having access a sub-space of a hierarchical 3D model space. The hierarchical 3D model space may include a plurality of nodes and at least one branch. The each node may include at least one version of a sub-component. The method may further include retrieving the sub-space that may include at least two sub-components each having a hierarchical relationship to the other. The method may also include transmitting the sub-space to the at least one of the plurality of users. The method may further include receiving from one of the plurality of users an updated sub-component forming a part of the sub-space. The method may also include transmitting the updated sub-component to the at least one of the plurality of users. The 3D model space may be accessible by multiple users over a network. The network may be the Internet. The each version of a sub-component may be accessible in a library associated with the 3D model space.

In accordance with exemplary and non-limiting embodiments, the present disclosure provides a system that may include a 3D modeling space configured for multi-user 3D design collaboration that may be accessible over a network by a plurality of client computers. The 3D modeling space may include a plurality of sub-spaces hierarchically distributed to a plurality of client computers. The system may also include at least one sub-component accessible in each of the distributed sub-spaces. The each of the at least one sub-component may be subordinate to a component that may be accessible in the 3D modeling space and at least a portion of the component may be not accessible in any of the plurality of sub-spaces. The network may be the Internet. At least one version of a sub-component may be accessible in a library associated with the 3D modeling space.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The method may further include transmitting a sub-space that may include a portion of the 3D model space to a user. The method may also include receiving from the user the sub-space that may include at least one updated sub-component. The method may further include integrating the at least one updated sub-component with the 3D model space. The 3D model space may be accessible by multiple users over a network. The network may be the Internet. The each version of a sub-component may be accessible in a library associated with the 3D model space. The sub-space may be transmitted in a target format. The way of transmitting may include translating the sub-space from a source format to a target format. The way of receiving may include receiving the at least one updated sub-component in the target format; and translating the at least one updated sub-component to a source format. The method may also include receiving a request from the user for the sub-space. The request may include the target format. The method may further include reducing a resolution of the at least one sub-component of the transmitted sub-space. The way of reducing may include culling a number of triangles defining the at least one sub-component of the transmitted sub-space. The way of reducing may include reducing the resolution of the at least one sub-component of the transmitted the sub-space based, at least in part, upon a screen resolution of a user interface of the user. The way of integrating the at least one updated sub-space may further include integrating the at least one updated sub-space that may include at least one new version of a sub-component with the hierarchical 3D model space.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The method may further include transmitting a sub-space that may include a portion of the 3D model space to a first user utilizing a first software tool. The method may also include transmitting the sub-space to a second user utilizing a second software tool. The method may further include receiving from the first user the sub-space that may include at least one updated sub-component. The method may also include receiving from the second user the sub-space that may include at least one updated sub-component. The method may further include integrating the at least one new sub-component from the first user and the at least one updated sub-component from the second user with the 3D model space. The 3D model space may be accessible by multiple users over a network. The network may be the Internet. The each version of a sub-component may be accessible in a library associated with the 3D model space. The sub-space may be transmitted in a first target format to the first user and in a second target format to the second user. The way of transmitting may include translating the sub-space from a source format to a first target format for the first user and a second target format for the second user. The way of receiving from the first user may include receiving the at least one updated sub-component in the first target format, and translating the at least one new sub-component to a source format. The way of receiving from the second user may include receiving the at least one updated sub-component in the second target format, and translating the at least one new sub-component to a source format. The method may further include receiving a request from the first user for the sub-space. The request may include the target format. The method may also include receiving a request from the second user for the sub-space. The request may include the target format.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The method may further include transmitting a sub-space that may include a portion of the 3D model space to a user. The method may also include receiving from the user the sub-space that may include at least one new sub-component. The method may further include integrating the at least one new sub-component with the 3D model space. The 3D model space may be accessible by multiple users over a network. The network may be the Internet. The each version of a sub-component may be accessible in a library associated with the 3D model space. The sub-space may be transmitted in a target format. The way of transmitting may include translating the sub-space from a source format to a target format. The way of receiving may include receiving the at least one new sub-component in the target format, and translating the at least one new sub-component to a source format. The method may also include receiving a request from the user for the sub-space. The request may include the target format. The method may further include reducing a resolution of the at least one sub-component of the transmitted sub-space. The way of reducing may include culling a number of triangles defining the at least one sub-component of the transmitted sub-space. The way of reducing may include reducing the resolution of the at least one sub-component of the transmitted the sub-space based, at least in part, upon a screen resolution of a user interface of the user. The way of integrating the at least one new sub-space may further include integrating the at least one new sub-space that may include at least one new version of a sub-component with the hierarchical 3D model space.

In accordance with exemplary and non-limiting embodiments, the present disclosure provides a system that may include a hierarchical 3D model space that may be accessible to client computers over a network. The at least two of the client computers may be adapted to execute disparate 3D modeling software tools. The system may further include a sub-space configured for multi-user collaboration. The sub-space may embody a portion of the 3D model space. The system may also include a plurality of sub-components that may be accessible in the sub-space. A first sub-component of the plurality of sub-components may be configured by 3D modeling software on one of the two client computers and a second sub-component of the plurality of sub-components may be configured by 3D modeling software on another of the two client computers. The 3D model space may be accessible by multiple users over a network. The network may be the Internet. At least one version of a sub-component may be accessible in a library associated with the 3D model space.

In accordance with exemplary and non-limiting embodiments, the present disclosure provides a system that may include a 3D modeling space configured for multi-user collaborative design. Components that may be accessible in the 3D modeling space may be represented by component data in a first geometric component data format. The systems may further include a plurality of sub-spaces that each may represent a three-dimensional portion of the 3D modeling space. The plurality of sub-spaces may be distributed to a plurality of client computers configured to execute disparate modeling software that may represent components in disparate geometric component data formats. The systems may also include a client computer interface facility of the 3D modeling space adapted to translate component data between the first geometric format and any of the disparate geometric component data formats to facilitate exchange of data between the 3D modeling space and the plurality of client computers. The 3D model space may be accessible by multiple users over a network. The network may be the Internet. At least one version of a sub-component may be accessible in a library associated with the 3D model space.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The method may further include receiving a request from a user for a sub-space of the 3D model space. The method may also include retrieving the requested sub-space in a source format. The method may further include translating the requested sub-space into a target format. The method may also include transmitting the requested sub-space to the user. The method may further include receiving the sub-space that may include at least one updated sub-component from the user, and translating the received at least one updated sub-component into the source format. The method may also include integrating the received at least one updated sub-component into the 3D model space. The 3D model space may be accessible by multiple users over a network. The network may be the Internet. The each version of a sub-component may be accessible in a library associated with the 3D model space. The request may include the target format. The request may include an identifier of a software tool. The method may further include deriving the target format from the identifier of the software tool.

In accordance with exemplary and non-limiting embodiments, the present disclosure provides a system that may include a 3D modeling space configured for a specific design genre that accessible over a network by a plurality of client computers. The 3D modeling space may include at least one sub-space for multi-user 3D design collaboration. The system may further include a sub-space specification that may identify an extent of the sub-space in three dimensions relative to the 3D modeling space. The system may also include a design component accessible in the sub-space by software executing on a portion of the plurality of client computers. The system may further include a component access facility for encoding the design component into a plurality of formats that may be compatible with the software executing on the portion of the plurality of client computers. The network may be the Internet. At least one version of a design component may be accessible in a library associated with the 3D modeling space. The design genre may include architectural modeling. The design genre may include automobile modeling. The design genre may include product modeling. The design genre may include aerospace modeling.

In accordance with exemplary and non-limiting embodiments, the present disclosure provides a method that may include receiving a request from at least one of a plurality of users each having access to a vertical sub-space of a hierarchical 3D model space. The hierarchical 3D model space may include a plurality of nodes and at least one branch. The each node may include at least one version of a sub-component. The method may further include retrieving the vertical sub-space. The method may also include transmitting the vertical sub-space to the at least one of the plurality of users. The plurality of users may access the 3D model space over a network. The network may be the Internet. The each version of a sub-component may be accessible in a library associated with the 3D model space. The method may further include receiving from one of the plurality of users an updated sub-component forming a part of the vertical sub-space, and transmitting the updated sub-component to the at least one of the plurality of users. The vertical sub-space may include an industry specific sub-space. The industry specific sub-space may be selected from a group consisting of automotive and architecture.

In accordance with exemplary and non-limiting embodiments, the present disclosure provides a system that may include a hierarchical 3D model space that may include a plurality of sub-spaces configured for multi-user collaboration. The each sub-space of the plurality of sub-spaces may embody a portion of the 3D model space. The system may further include a plurality of sub-components accessible in the plurality of sub-spaces. A first sub-component of the plurality of sub-components may be accessible in a first sub-space, and a second sub-component of the plurality of sub-components may be accessible in a second sub-space. The system may also include a component that may be accessible in the 3D model space that may include each of the plurality of sub-components. The component may not be fully accessible in any one of the plurality of sub-spaces. The 3D model space may be accessible by multiple users over a network. The network may be the Internet. At least one version of a sub-component may be accessible in a library associated with the 3D model space.

In accordance with exemplary and non-limiting embodiments, the present disclosure provides a system that may include a 3D modeling space that may be accessible over a network by a plurality of client computers. The 3D modeling space may include at least one sub-space for multi-user 3D design collaboration. The system may further include a sub-space specification that may identify an extent of the sub-space in three dimensions relative to the 3D modeling space. The system may also include an application data store accessible through the 3D modeling space. The application data store may include a plurality of applications for processing model data accessible in the sub-space. The plurality of applications may include a simulation tool. The simulation tool may include a finite element analysis. The simulation tool may include a fluid dynamics analysis. The plurality of applications may include a rendering tool. The plurality of application may include a prototyping tool. The plurality of applications may include a manufacturability analysis. The plurality of applications may include a failure mode analysis. The plurality of applications may include a facade generator. The network may be the Internet. The model data may be accessible as at least one sub-component in a library associated with the 3D model space.

In accordance with exemplary and non-limiting embodiments, the present disclosure provides a method that may include providing a selection of a plurality of applications for operation upon a 3D model space to a user. The method may further include receiving a request for at least one of the plurality of applications. The request may include an identifier of a 3D model space. The method may also include applying the requested at least one of the plurality of applications to the identified 3D model space to obtain a result. The method may further include transmitting the result to the user. The 3D model space may be accessible by multiple users over a network. The network may be the Internet. Each version of a sub-component may be accessible in a library associated with the 3D model space. The requested of one of the plurality of applications may include a simulation tool. The simulation tool may include a finite element analysis. The simulation tool may include a fluid dynamics analysis. The requested of one of the plurality of applications may include a rendering tool. The requested of one of the plurality of applications may include a prototyping tool. The requested of one of the plurality of applications may include a manufacturability analysis. The requested of one of the plurality of applications may include a failure mode analysis. The requested of one of the plurality of applications may include a facade generator.

In accordance with exemplary and non-limiting embodiments, the present disclosure provides a method that may include providing a selection of a plurality of applications for operation upon a 3D model space to a user. The method may further include receiving a request for more than one of the plurality of applications. The request may include an identifier of a 3D model space. The method may also include applying the requested of more than one of the plurality of applications to the identified 3D model space to obtain a result. The method may further include transmitting the result to the user. The requested of more than one of the plurality of applications may include an application selected from the group consisting of a simulation tool, a rendering tool, a prototyping tool, a manufacturability analysis, a failure mode analysis, and a facade generator. The simulation tool may include finite element analysis. The simulation tool may include fluid dynamics.

In accordance with exemplary and non-limiting embodiments, the present disclosure provides a method that may include providing a hierarchical 3D model space. The hierarchical 3D model space may include a plurality of nodes and at least one branch. The each node may include at least one version of a sub-component. The each of the at least one version may include one or more attributes. The method may further include providing a representation of a workflow to be performed upon a sub-space of the 3D model space. The workflow may be a circuit diagram. The 3D model space may be accessible by multiple users over a network. The network may be the Internet. The each version of a sub-component may be accessible in a library associated with the 3D model space.

In accordance with exemplary and non-limiting embodiments, the present disclosure provides a method that may include providing a distributed 3D model space. The distributed 3D model space may include a plurality of nodes and at least one branch. The each node may include at least one version of a sub-component. The each of the at least one version may include one or more attributes. The method may further include providing a representation of a workflow to be performed upon a sub-space of the 3D model space. The workflow may be a circuit diagram. The 3D model space may be accessible by multiple users over a network. The network may be the Internet. The each version of a sub-component may be accessible in a library associated with the 3D model space.

In accordance with exemplary and non-limiting embodiments, the present disclosure provides a system that may include a 3D model space configured for multi-user collaboration over a network. The 3D model space may be concurrently accessible to a plurality of distributed users. The system may further include a sub-space of the 3D model space. The sub-space may include a distinct three-dimensional region of the 3D model space, and at least one component of the 3D models pace may be accessible in the sub-space. The system may also include an expert collaboration portal of the 3D model space that may facilitate collaboration with consultants that may be expert on subject matter associated with the at least one component that may be accessible in the sub-space. The network may be the Internet. At least one version of a component may be accessible in a library associated with the 3D model space.

In accordance with exemplary and non-limiting embodiments, the present disclosure provides a method that may include receiving a request from at least one of a plurality of users. Each user may have access to a sub-space of a hierarchical 3D model space that may include a plurality of nodes and at least one branch. The each node may include at least one version of a sub-component. The method may further include retrieving the sub-space. The method may also include transmitting the sub-space to the at least one of the plurality of users. The method may further include providing access to the sub-space to an expert. The 3D model space may be accessible by multiple users over a network. The network may be the Internet. The each version of a sub-component may be accessible in a library associated with the 3D model space.

In accordance with exemplary and non-limiting embodiments, the present disclosure provides a system that may include a 3D model space configured for multi-user collaboration over a network. The 3D model space may be concurrently accessible to a plurality of distributed users. The system may further include a sub-space of the 3D model space. The sub-space may include a distinct three-dimensional region of the 3D model space, and at least one component of the 3D models pace may be accessible in the sub-space. The system may also include an expert collaboration portal of the 3D model space that may facilitate collaboration with consultants that may be expert on subject matter associated with the at least one component that may be accessible in the sub-space. The system may further include a user interface of the expert collaboration portal that may facilitate engaging one of a plurality of subject matter experts in collaboration by providing the one of a plurality of subject matter experts with access to the sub-space. The network may be the Internet. Each version of a component may be accessible in a library associated with the 3D model space.

In accordance with exemplary and non-limiting embodiments, the present disclosure provides a method that may include receiving a request from at least one of a plurality of users each that may have access to a sub-space of a hierarchical 3D model space. The hierarchical 3D model space may include a plurality of nodes and at least one branch. The each node may include at least one version of a sub-component. The method may further include receiving a request from an expert for access to the sub-space. The method may also include retrieving the sub-space. The method may further include transmitting the sub-space to the at least one of the plurality of users and the expert. The 3D model space may be accessible by multiple users over a network. The network may be the Internet. The each version of a sub-component may be accessible in a library associated with the 3D model space. These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

For a more complete understanding of the present invention, reference is now made to the following descriptions taken in conjunction with the accompanying drawing, in which:

FIG. 1 illustrates a top level block diagram of a 3D collaborative design platform;

FIG. 2 illustrates a block diagram of a deployment environment associated with an architecture of the 3D collaborative design platform;

FIG. 3 illustrates a schematic diagram of architectural elements of a 3D collaborative design platform;

FIG. 4 illustrates a hierarchical node-based diagram of the 3D platform;

FIG. 5 illustrates a user interface for facilitating the selection of sub-components forming a component;

FIG. 6 illustrates a collaborative 3D design platform as may be viewed by two users collaborating via the 3D platform;

FIG. 7 depicts certain elements of an application store accessible through a 3D collaborative modeling design platform;

FIG. 8 depicts a screen shot of a user interface of the application store of FIG. 6;

FIG. 9 depicts a user interface for accessing the design platform;

FIG. 10 depicts a user interface of a 3D collaborative design platform for visually laying out computational processes;

FIG. 11 depicts a user interface of a 3D collaborative design platform in which elements and sub-spaces of the platform are represented in a three-dimensional design space;

FIG. 12 depicts a broadcast interface that may facilitate accessing a broadcasting capability of the platform to create and maintain a showcase;

FIG. 13 depicts a flow chart of a method of selecting a version of a sub-component based on an attribute associated with the subcomponent;

FIG. 14 depicts a flow chart of a method for rendering a version of a sub-component in response to a user selection;

FIG. 15 depicts a flow chart of a method for automatically determining a version of a sub-component in response to selection criteria;

FIG. 16 depicts a flow chart of a method for rendering the sub-component in a 3D model space;

FIG. 17 depicts a flow chart of a method for providing a distributed version control;

FIG. 18 depicts a flow chart of a method for storing an updated version of a sub-component;

FIG. 19 depicts a flow chart of a method for selecting a hierarchical tree from a distributed 3D model space;

FIG. 20 depicts a flow chart of a method for maintaining a node of a 3D model space;

FIG. 21 depicts a flow chart of a method for managing hierarchical version in distributed 3d modeling space;

FIG. 22 depicts a flow chart of a method for storing different versions of a sub-component in a same node;

FIG. 23 depicts a flow chart of a method for transmitting information indicative of a use of the sub-space in the 3D model space;

FIG. 24 depicts a flow chart of a method for transmitting a portion of a sub-space to a user interface;

FIG. 25 depicts a flow chart of a method for retrieving a portion of a sub-space based upon a viewing direction and viewing location;

FIG. 26 depicts a flow chart of a method for transmitting a sub-space including at least two sub-components having a hierarchical relationship;

FIG. 27 depicts a flow chart of a method for integrating an updated sub-component with the 3D model space;

FIG. 28 depicts a flow chart of a method for transmitting a sub-space in a target format;

FIG. 29 depicts a flow chart of a method 2900 for processing a 3D model space using an application; and

FIG. 30 depicts a flow chart of a workflow for collaboration in a 3D shared modeling space.

### DETAILED DESCRIPTION

The present invention provides a real-time collaborative design platform that may democratize access to high performance tools. The platform may enable designers and state of the art research laboratories to achieve a larger footprint for their design and analysis tools. A delivery mechanism is provided that may achieve low barriers to access, harnesses a global community of users and developers, and may enable seamless interdisciplinary collaboration. The platform described herein may respond to these challenges by casting a CAD architecture into a networked platform for real-time collaboration. This architecture may significantly speed up and may support creativity in the early design phase enabling rapid design iterations, complex analysis, real-time analytics and centralized workflow management in a collaborative setting.

Further, various applications may be launched on the platform. The platform may provide multiple features to such applications. In an embodiment, the platform may provide shared 3D model space to enable synchronous remote collaboration. In another embodiment, the platform may provide multiple perspectives/workbenches to allow multidisciplinary conversations. The platform may also support an application store that may enable generation of custom software solutions and facilitate sharing to reduce tool redundancy. In a preferred embodiment, the platform may provide pay-per-use access to remove cost-barriers for global access.

The platform may facilitate designers to achieve greater reach, access immediate feedback and influence a global community of users by creating and sharing applications addressing demanding design challenges. The platform may be used in applications such as increasing impact through energy simulation and optimization, and achieving higher performance in complex design.

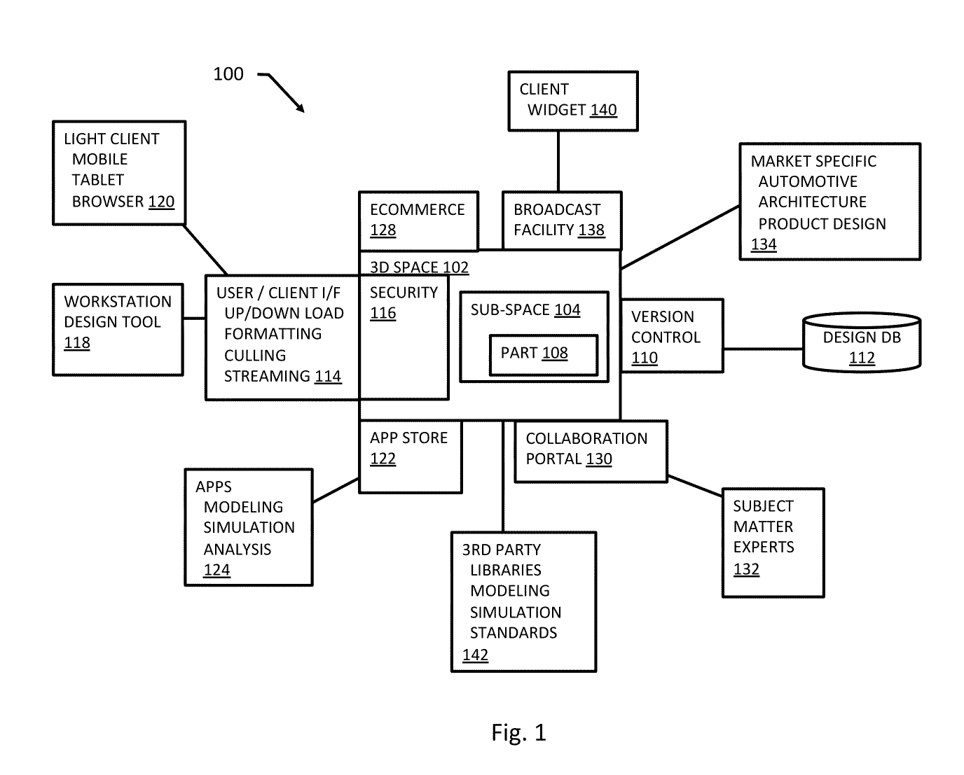

With reference to FIG. 1, there is illustrated an exemplary and non-limiting embodiment of a block diagram of various elements of a collaborative 3D design platform 100. A 3D design space 102 as described herein may facilitate collaborative design of 3D (and 2D) models, and the like. The 3D design space 102 may be sub divided into sub-spaces such as sub-space 104. A 3D or 2D part or component 108 may be disposed within the 3D space 102 and/or within a sub-space 104. Version control of the space 102, sub-space 104, component 108, and the like may be coordinated by a version control facility 110 that may be distributed and may further facilitate access to any of the design elements (e.g. parts, models, components, sub-components, metadata, project data, libraries, and the like) in a design database 112. The platform 100 may be accessed by a user through a user/client interface 114 that may facilitate providing access to the 3D space 102 for light client-type devices 120 (e.g. mobile devices, tablet devices, web-browsers, and the like) by providing data as needed via streaming, culling, encoding, and the like that is suitable for the light client environment. Similarly, the user/client interface 114 may facilitate up/download of various aspects of the platform to a workstation 118 or equivalent system that may include a design tool, such as commercially available 3D design and modeling software. In coordination with the version control facility 110, the user/client interface 114 may enable a user to gain access to the 3D space 102, a sub-space 104, a component 108, and the like as described further herein. Security, such as authentication of user access to a requested aspect of the platform may be provided by a security facility 116 that may ensure that a user only has access to the portion(s) of the platform (e.g. a specific component 108 in a specific sub-space 104) to which he/she is authenticated to access. The platform 100 may further comprise an app store 122 that may facilitate access to applications 124 such as modeling software, simulation tools, analysis functionality, and the like. An ecommerce facility 128 may facilitate generating revenue for an operator of the platform such as through the sale or rental (e.g. pay-per-use) of one or more of the apps 124 that maybe available through the app store 122. The ecommerce facility 128 is envisioned to facilitate generating revenue through other aspects of the platform 100, such as for premium data storage in the design database 112 and the like. The platform 100 is further envisioned to facilitate a robust collaborative workflow that may provide metered and/or guided access to subject matter experts 132 through a collaborative portal 130. The platform 100 is also envisioned to participate in market specific applications and therefore may be customized for use in markets 134 such as automotive 3D design, architecture/construction, product design, and the like. At least because the platform 100 is envisioned to be a collaborative platform that may be used by various communities of users, a broadcast facility 138 may be supported by the platform for informing users of important information/updates/status of the platform 100 and/or projects. To facilitate efficient and targeted communication to users, a client widget 140 may be available for installation at a user's client device for interacting with the broadcast facility 138. To the extent that the platform 100 may be an open environment for collaboration, the platform 100 may provide access to third party capabilities 142 and features, such as application-specific libraries, subject-matter domain specific standards, beta and trial simulation functionality, and the like.

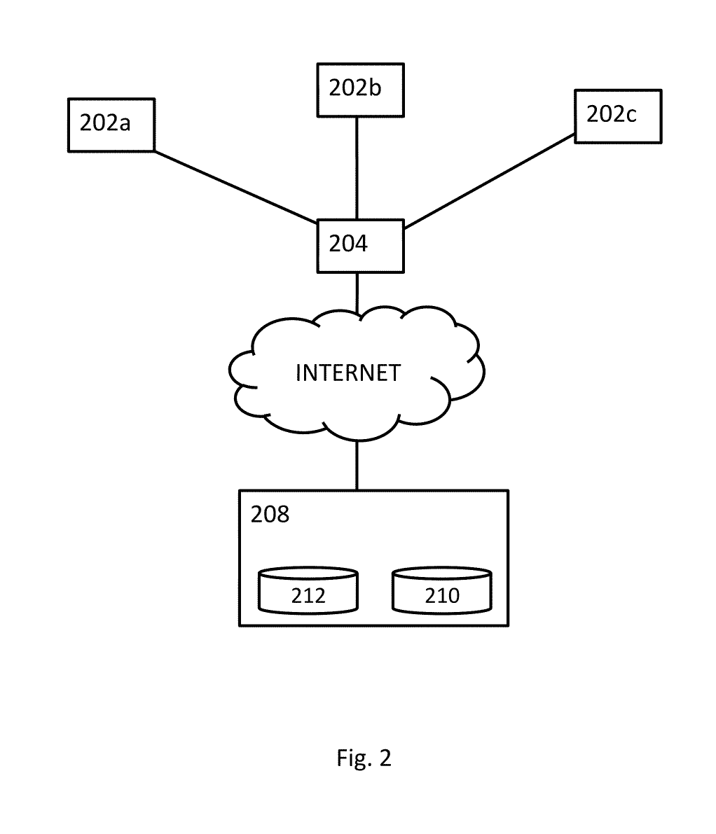

With reference to FIG. 2, there is illustrated an exemplary and non-limiting embodiment of a block diagram of the design platform 100. As illustrated, one or more user devices 202a-c communicate with front a end server 204. The user devices 202 may be any form of computing device capable of receiving inputs from users, such as via a user interface, and transmitting such input to a back end server 208, such as via the front end server 204. Each user device 202 is further capable of receiving data communicated from the back end server 208, such as via the front end server 204, and optionally storing such received data. Examples of user devices 202 include, but are not limited to, personal computer, tablet computers, mobile phones, notebooks, smart phones, desktops, and the like. Communication between the user devices 202, the front end server 204, and the back end server 208 may be wired or wireless. Such communication may further be transmitted over a network including, but not limited to, the Internet.

In general, the front end server 204 operates to receive and manage requests from the user devices 202 and to interact with the back end server 208 to fulfill requests from the user devices 202. As described more fully below, front end server may comprise discreet units of executable code for managing connections with the user devices 202, for managing user interfaces on the client devices 202, for detecting and responding to defined events on the user devices 202 and for managing the selection, acquisition and distribution of apps by, for and to the user devices 202.

In accordance with exemplary embodiments, the front end server 204 may be delivered through a mobile browser. In an embodiment, a mobile hardware may be developed such as an HTML5 client that may be universally used across all lightweight as well as heavyweight client and/or mobile hardware. In another embodiment, a desktop thin client (Java or C++) for Windows/MacOS/Linux or other client may be developed to de-risk the design platform 100 against using experimental web technologies only.

While illustrated as separate entities, the user device 202 and the front end server 204 may, in some exemplary embodiments, comprise a unitary device. In general, the back end server 208 operates to receive and manage requests from the user devices 202 such as may be received via the front end server 204. As illustrated, the back end server 208 comprises at least one model database 210. The model database may store 3D model spaces in hierarchical fashion. Such data may include digital representations of components and sub-components as well as metadata comprising, for example, attributes describing components and sub-components. An application database 210 may store data ancillary to the 3D model spaces. Examples of such data include, but are not limited to, information for authenticating users, particularly groups of collaborating users, account data of users, data descriptive of sub-spaces of 3D modeling spaces, and the like. While described as separate databases, it is understood that in practice both of the application databases 210 and 212 may be implemented in a single database in communication with the server 208. In an embodiment, JAVA enterprise solutions may be used for the backend server 208 comprising a backend cluster framework.

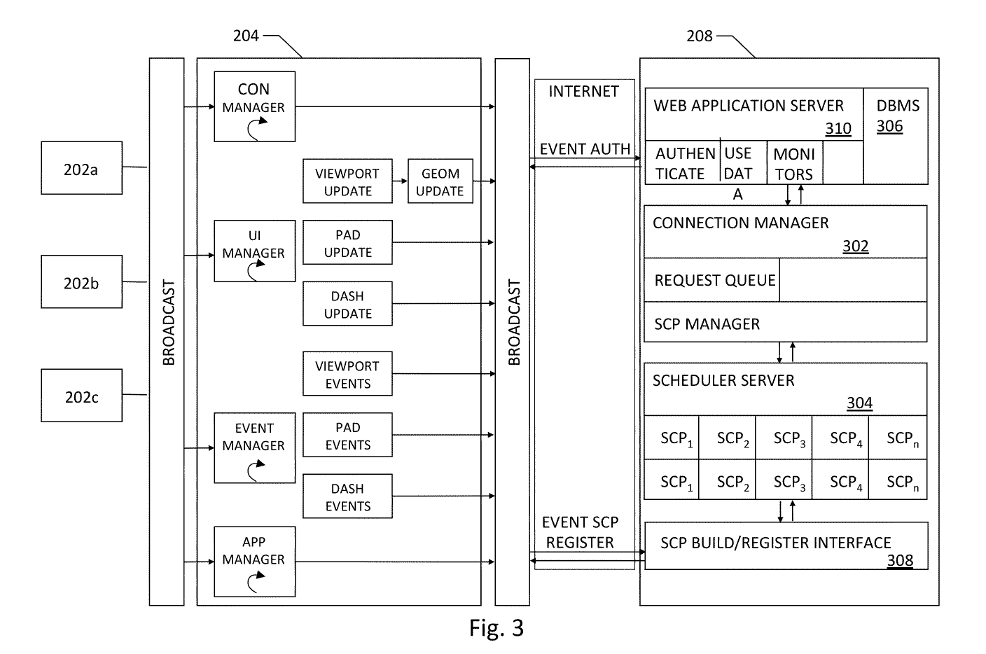

With reference to FIG. 3, there is illustrated a more detailed exemplary and non-limiting embodiment of the design platform 100. As illustrated, the back end server 208 comprises web an application server 310, a connection manager 302, a scheduler server 304 and a SCP build/register interface 308. While illustrated as comprising various separate functional components, it is understood that such components may be combined in practice in various configurations to achieve the same or similar results. In addition, data described above as stored in the databases 210, 212 may be stored in singular or distributed fashion amongst the component elements of the back end server 208 including, but not limited to, a database management system 306.

In accordance with an exemplary and non-limiting embodiment, the web application server 310 operates to manage communication with the front end server 204 via, for example, the Internet. As illustrated, the application server 310 performs various tasks related to, but not limited to, user authentication, managing platform use data, retrieval and storage of 3D model space data and other data, such as in the database management system 206. The web application server 310 may communicate with the connection manager 302 comprising a request queue for storing requests from the web application server 310 and a response queue for storing responses to the web application server 310. The connection manager 302 may further comprise a standard communication protocol (SCP) manager for interfacing with the server 304. The server 304 comprises a scheduler module for scheduling the execution of requested processes the results of which are formatted in an SCP format at an SCP build/register interface 308 and communicated to the front end server 204.

As illustrated, the front end server 204 detect and manages received requests and authorization information from multiple user devices 202, such as via user interfaces forming a part of the user devices 202, and manages communications with the back end server 208.

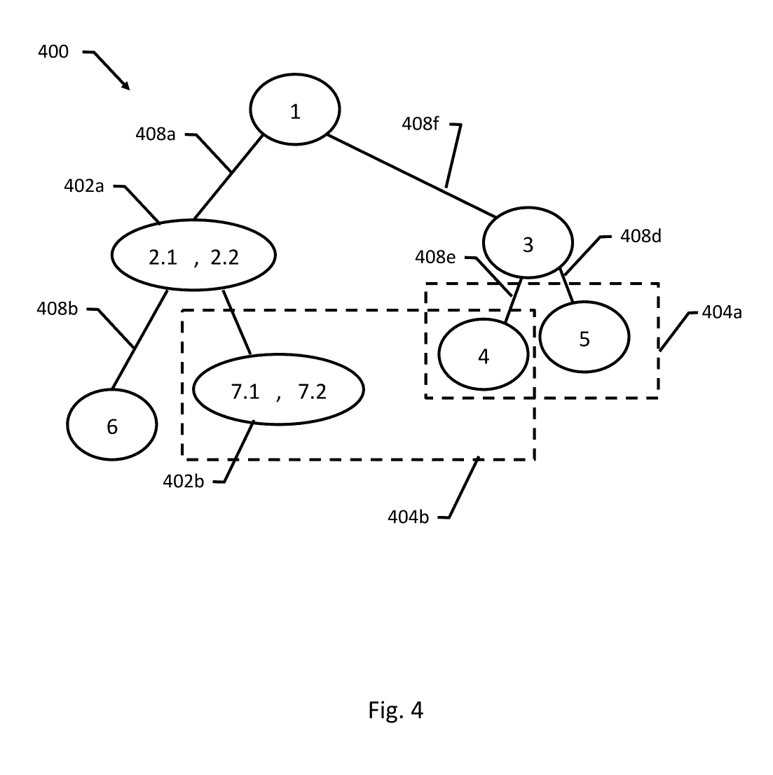

With reference to FIG. 4, there is illustrated a block diagram of a 3D model space 400 according to an exemplary and non-limiting embodiment. The 3D model space 400 comprises a plurality of nodes 402 arranged in a hierarchical manner connected by branches 408. As illustrated, each node 402 is numbered (e.g., 1, 2, 3, . . . 7, etc.) with an identifier of a sub-component. As used herein, references to nodes 402, such as “node 1” and “sub-component 1” refer interchangeably to both the node 402 and the sub-component and/or component represented as residing at node 402 having an identifier, such as “1”. Taken together, the sub-components residing at nodes 402, connected by the branches 408 extending from a top, or highest order, node 402 and extending downwards and/or outwards to a terminus of each branch, form a component, such as resides in the present example at node 1. Alternatively, a component may be referred to as an assembly of components, sub-components, and the like.

As illustrated, the component of node 1 is comprised of two sub-components, node 2 and node 3. Node 2 is further comprised of sub-components node 6 and node 7. Likewise, node 3 is comprised of sub-components node 4 and node 5. As illustrated, at each of node 2 and node 7 there reside more than one version of a sub-component. Specifically, at node 2 there resides a first version of sub-component 2 (version 2.1) and a second version of sub-component 2 (version 2.2). Likewise, at node 7 there resides a first version of sub-component 7 (version 7.1) and a second version of sub-component 7 (version 7.2). Further, collections of one or more nodes 402 may form a sub-space 404. In the present example, the sub-space 404a comprises node 4 and node 5 while the sub-space 404b comprises node 7 and node 4. As is evident, different sub-spaces may comprise overlapping sub-components.

Note that different versions of sub-components are distributed throughout the 3D model space 400 at various nodes 402. For example, consider the 3D model space 400 as comprising 3D model information for various sub-components forming a component computer and power source. In such an example, node 1 represents the entire component including the computer and power source. Node 2 represents sub-component 2 forming the computer while node 3 represents the power source. The computer may further be formed of a display (sub-component 6) and a keyboard (sub-component 7). Likewise, the power source (sub-component 3) may further be formed of a plug (sub-component 4) and a cord (sub-component 5).

As illustrated, there may be no one “version” of the component computer and power source represented by and stored in the 3D model space 400. Rather, it is possible to assemble various different iterations of component 1, the computer and power source, by choosing different versions of sub-components as the branches 408 and nodes 402 are traversed. This might be the case when any component or sub-component in the 3D model space 400 is edited, modified, downloaded, or otherwise acted upon so as to result in a reference to at least one additional version of at least one of the sub-components being identified in the 3D model space 400 or a sub-space thereof. As used herein, “[component 1-(2.1-(6)(7.1))(3-(4)(5))]” refers to a component 1 formed from branch 408a to version 2.1 of sub-component 2 and branch 408f to sub-component 3. Version 2.1 of sub-component 2 is formed from branch 408b to sub-component 6 and branch 408c to version 7.1 of sub-component 7, and sub-component 3 is formed from branch 408e to sub-component 4 and branch 408d to sub-component 5. The resulting component 1 is but one iteration created by the selection of different versions of sub-components, specifically, version 2.1 of sub-component 2 and version 7.1 of sub-component 7. For example, other iterations of component 1 could be formed as [component 1-(2.2-(6)(7.2))(3-(4)(5))] which chooses version 2.2 of sub-component 2 and version 7.2 of sub-component 7, [component 1-(2.1-(6)(7.2))(3-(4)(5))] which chooses version 2.1 of sub-component 2 and version 7.2 of sub-component 7, etc.

The version control capabilities described herein might be distributed so that a user who has ownership of a node may define versions of a component (or sub-component) associated with the node to inherit a specific version from a lower level node/sub-component. In an example, owner of component 1 may configure a version of this component (e.g. version 1.1) so that a specific arrangement of sub-components is identified when the version is selected. In the example, version 1.1 of component 1 might comprise [component 1-(2.1-(6)(7.1))(3-(4)(5))], while version 1.2 of component 1 might be composed of [component 1-(2.2-(6)(7.2))(3-(4)(5))], and the like. In this way, versions of sub-components may be directly associated with versions of sub-components higher up in the branching hierarchy.

This distributed version control may extend downward in the branch/node hierarchy so that an owner of a node (e.g. the node associated with sub-component 2) may create a version of sub-component 2 that includes a specific version of a lower level sub-component. In an example, version 2.1 of sub-component 2 might be configured to link only with version 7.1 of lower level sub-component 7. The techniques for version selection described herein may be used to make such an assignment. In this way an owner of a sub-component can control how upper level components and/or assemblies access the various versions of lower level sub-components.

A 3D model space, such as the 3D model space 400 may include sub-spaces that may represent a three-dimensional portion of the 3D model space. As noted above, a sub-space may comprise one or more nodes 402. Likewise, a sub-space may comprise one or more components or sub-components. A sub-space may be owned by an owner (e.g. a user of the 3D model space) who may control how versions of nodes, components, and/or lower level nodes or sub-components are managed in the sub-space. Much like an owner of a node can create a version of a sub-component that includes a specific version of a lower level sub-component, an owner of a sub-space may control (e.g. through the version selection and control techniques described herein) which versions of nodes, components, sub-nodes, sub-components and the like that are associated with the sub-space are included in references to the sub-space. In an example, if a sub-space owner determines that sub-components designed by user X cannot be used when the sub-space is integrated into the 3D model space, then any versions of components or sub-components associated with the sub-space that were designed by user X may not be accessible in the 3D model space from outside of the sub-space. Note that owners of sub-spaces may have access rights (and may grant such rights to other users) that may allow access to components in the sub-space that are not accessible to others; therefore the sub-space owner above may have visibility to components designed by user X even though such components may not be accessible to be used in a higher level component of the 3D model space.

As may be evident, the 3D model space 400 supports the distribution of version control at the sub-component level so as to support the definition of various versions of components based upon defined preferences. Different versions of sub-components may be selected for inclusion in forming the component based on various factors. For example, as noted above, versions of sub-components may be tagged with attributes such as price, cost, license status/clearance, strength, stress/strain, weight, material properties, geometry and the like. Some attributes such as, for example, price, may be entered by a user, such as via a user interface of the user device 202, while other attributes such as, for example, geometry, may be computed by the platform 100. Using these attributes, branches and/or iterations of a component may be selected based, for example, upon business rules and constraints, performance criteria, compatibility rules, compatibility based on geometry and the like.

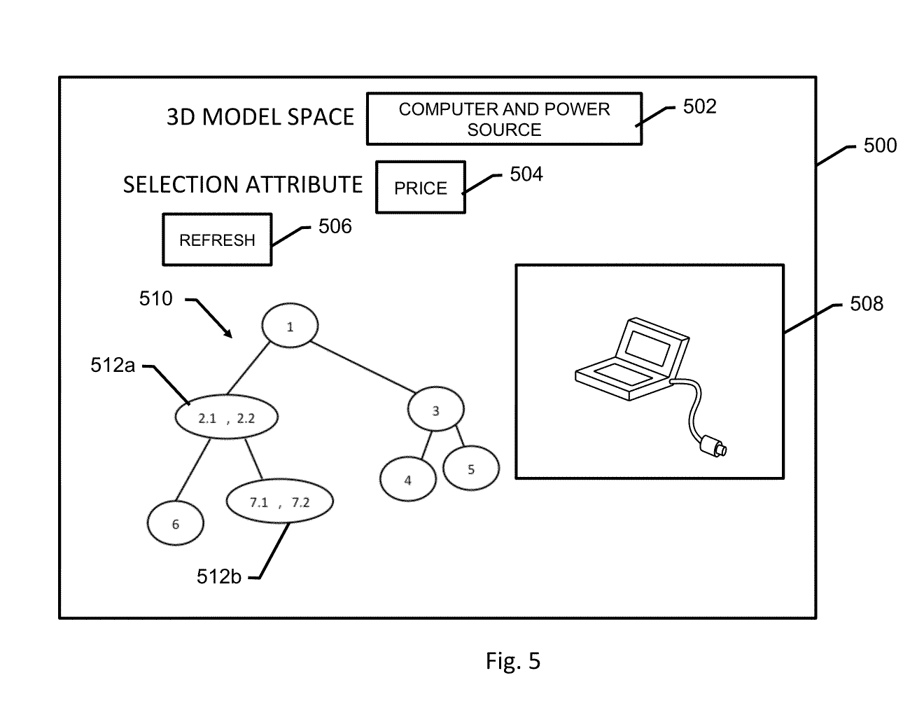

With reference to FIG. 5, there is illustrated an exemplary and non-limiting embodiment of a user interface 500, such as might be displayed on a user device 202, for facilitating the selection of sub-components forming a component. As illustrated, the user interface 500 comprises various input fields 502, 504 for entering information. While illustrated using text fields, it is understood that such information may be entered using any and all graphical user interface (GUI) conventions including, but not limited to, drop down lists, radio buttons and the like. In the example illustrated, the model space field 502 indicates a selection of a 3D model space representing the computer and power source of the previous example. Further, the selection criteria field 504 indicates a selection of price as the attribute to be used when navigating the 3D model space 400. Once entered, the data of the input fields 502, 504 may form the input for a request to the back end server 208 to access a portion of the requested 3D model space 400. By using these fields, the user interface may facilitate selection of one or more versions of components and/or sub-components based on a relationship between attribute(s) associated with the version(s) of the sub-components and the selection criteria of price. In a further example, if a price attribute criteria, such as least cost of raw materials is identified, then only versions of each component that result in the least raw material cost would be accessed. Another selection criteria field 504 entry might be related to version date so that only the most recently changed version of each sub-component might be selected from the 3D model space. Also combinations of selection criteria (e.g. multiple attribute values, more than one business rule, combinations of price and availability, etc.) may be specified and applied in the version selection techniques described herein for use in a 3D model space, such as the variants of the 3D model space 400 described herein.

As illustrated, there is displayed a model space diagram 510 as might be returned from the back end server 208, such as via the front end server 204. The model space diagram 510 may be a graphic depiction of the model data accessed and transmitted by the back end server 208 and received and displayed by the user device 202 and/or the front end server 204. Alternatively, data representing the graphic depiction may be transmitted to the user device 202 for display thereon. In an exemplary embodiment, the model space diagram 510 may depict only those nodes and sub-components for which requested data was received (e.g. only certain component versions, only certain sub-spaces, only certain nodes, only nodes above/below a level in the component hierarchy, only components to which the requesting user is authorized to access, and the like). In an exemplary embodiment, as shown, a version indicator 512 is any visual indicia, such as highlighting or other emphasis rendering means, that indicates a sub-component chosen on the basis, at least in part, of one or more of the sub-component's attributes. In the present example, such an attribute may be the price of the product.

The user interface 500 may operate to gather information and data from a user to guide the selection of components and sub-components from the 3D model space 400 stored on the back end server 208 as well as to display the results of selections or requested operations retrieved from or performed upon the back end server 208. As a result, the user interface 500 may enable real-time interaction with data stored on the back end server 208 as well as with other users, such as users operating separate user devices while collaborating on a sub-space. A user may select a node in the model space diagram 510, such as a node having a version indicator 512 to see a listing of various attributes attendant to the node. In the present example of choosing a version of a sub-component based on a price attribute, the model space diagram 510 depicts a portion of the 3D model space 400. A node in the model space diagram 510 comprises more than one version of a sub-component, the version of the sub-component that is accessed when the node is selected may be selected based, at least in part, on the price of the sub-component version.

Clicking or otherwise selecting the highlighted node having a version indicator 512 may list the attributes of the selected sub-component including, but not limited to, the price of the sub-component. In one embodiment, a user may utilize such a listing, or other formatted display of attribute data, to select a different or additional attribute and to resubmit the query to the back end server 208 for an updated iteration of 3D model space data matching the newly entered parameters. In this manner, a model space diagram 510 resulting from a query involving a single attribute, for example “price”, may be preferentially augmented at the sub-component or sub-space level based upon one or more additional attributes.

In an exemplary embodiment, a model space rendering 508 is a rendering of the component and/or subcomponent as represented in the model space diagram 510. The model space rendering 508 may be, but is not limited to, a perspective rendering, a planimetric rendering and the like. In an exemplary embodiment the model space diagram 510 and the model space rendering 508 are logically linked so that each reflects a near current state of the other. For example, if a user makes a change to a selected attribute corresponding to a highlighted sub-component as described above and requests an updated model space diagram from the back end server 208, an updated model space diagram 510 may be displayed at approximately the same time as an updated model space rendering 508 is displayed. In this manner, changes to selected attributes in the model space diagram 510 result in near real-time changes to the model space rendering 508 allowing a user to readily visualize changes to sub-component attribute and version selections.

Though described as forming a portion of the user interface 500, model space rendering 508 may comprise a separate user interface in asynchronous or synchronous communication with the user interface 500 such as might comprise a third party modeling software package. As a result, the user interface 500 operates to coordinate the display of rendering data with third party modeling software. In this manner, users may leverage expertise on particular modeling software while interfacing with the more generic user interface 500. The version selection techniques described herein for selecting one or more sub-components from a 3D modeling space may be integrated with third-party modeling software programs so that the rendering and 3D/2D manipulation capabilities of the third-party software may be used to create and/or modify a sub-component that has been accessed from the 3D model space. The third-party user interface may therefore include a depiction of the 3D model space and/or version selection as described herein along with a separate region for component editing, analysis, and the like. To the extent that component data in the 3D model space may be stored in a different format than that required by the third-party model editor, format transformation may be performed in substantially real-time as component(s) are downloaded from and/or uploaded to the 3D model space from the third-party user interface. In an embodiment, a user interface may include a first portion that represents information, including graphic or hierarchical information about one or more sub-components in the 3D model space, and a second portion for editing the one or more sub-components with a model editing software that is separate from the 3D model space, wherein the user can control downloading of the one or more sub-components from the 3D model space for editing with the model editing software and uploading of a new version of the one or more sub-components from the model editing software to the 3D model space.

As noted above, attributes corresponding to sub-components and components may be entered by a user, such as via the user interface 500, or may be automatically computed by the back end server 208. For example, attributes related to a sub-component's strength or resistance to aerodynamic stress or the like may be computed and added to a sub-component's attributes. In accordance with exemplary and non-limiting embodiments, some combinations of sub-components may be logically compatible but physically incompatible. Referring once again to the example of FIG. 5, sub-component 2 version 2.1 may be physically incompatible with sub-component 7 version 7.2. In such an instance, the user interface 500 may display a model space diagram 510 with a visual indicia, such as via outlining a node in red or displaying an error message, alerting the user to the physical incongruity and requesting a revised selection or selection criteria to rectify the problem. Once alerted, a user might utilize the user interface 500 to make a choice or selection or to enter alternative selection criteria to rectify the observed incongruity.

In accordance with some exemplary and non-limiting embodiments, a user may select a node of the model space diagram 510 and request that all sub-components at that node be displayed. In response, a request is sent to the back end server 208, which retrieves the desired data and transmits the data to the user interface 500, such as via the front end server 204. In response, the user may be enabled to click or otherwise toggle from one version of the sub-component to another version of the sub-component in serial fashion while observing visual changes in the selected configuration in the model space rendering 508.

The back end server 208 may store each 3D model space 400 in a data format or formats comprising a maximum data resolution for each 3D model or portion of 3D model representing each component and/or subcomponent. As described more fully below, the design platform 100 enables real-time or near real-time collaboration amongst more than one user on a sub-space basis. Specifically, a plurality of users may define and request a sub-space 404 of the 3D model space 400 from the back end server 208. The sub-space may be delivered to the front end server 204 from whence it may be accessed by the user devices 202. In such an exemplary embodiment, the front end server 204 may function as a central data depository for the sub-space 404 data to enable coordinated access to the sub-space data 404 by the user devices 202. In accordance with other exemplary embodiments, sub-space data may be transmitted to and stored at each of the plurality of user devices engaging in collaboration and having access to the sub-space 404 data. In yet other exemplary embodiments, a hybrid method of storage may allow for storage of the sub-space 404 data at both the front end server 204 and the user devices 202.

Regardless of the method by which requested data is received and stored by the front end server 204 and the user devices 202, selection and delivery of the 3D model space 400 data may be configured based upon resolution requirements of the requesting the user device 202. The 3D model space 400 stores geometric data describing the physical structure of components and sub-components as well as attendant attributes describing corresponding components and sub-components. Examples of data formats in which the 3D model space 400 data may be stored include, but are not limited to, 3DS, OBJ, STL, Blend, DAE, SolidWorks, Autodesk Inventor, CATIA, Creo, I-deas, IGES/STEP, IFC, JT, Parasolid, PRC, Pro/Engineer, Siemens PLM/NX, Solid Edge, VDA-FS and VRML files, OBJ, STL, DXF etc. In general, such data formats define, at a minimum, a plurality of connected triangles in three dimensional space forming the various surfaces of components and sub-components. For a high resolution description of a sub-component, the size of the geometric data describing the sub-component may be quite large. More specifically, the level of detail may be in excess of that which is preferred or desired by a user or users working in a collaborative manner.

In such instances, in accordance with exemplary embodiments, it may be desirable to cull the triangles forming the sub-components of a requested sub-space prior to transmission by the back end server 208. Various techniques and algorithms are known to those skilled in the art for culling large volumes of triangles forming a 3D model while preserving, to a predetermined degree, the basic structure of pre-culled 3D model. In accordance with exemplary embodiments, back end server may cull the results of selected sub-components forming a sub-space 404 prior to transmission based upon a viewing location of the requesting user and/or user device 202 within the 3D model space 400. Alternatively, the front end server 204 and/or a client interface facility may cull the model data prior to or as part of an outgoing encoding or format conversion process that results in culled, encoded data that is suitable for rendering on display of a specific target user device 202.

For example, consider a sub-space comprising a component manufacturing facility comprising a first and second sub-component building wherein the second sub-component building branches to a version of a sub-component generator located within the second sub-component building. If, such as via a user interface of the user device 202, a user is viewing a perspective rendering of the interior of the second sub-component building wherein the viewpoint is in proximity to the sub-component generator, the request sent from the user device 202 and received by the back end server 208 may include view point information, such as an x, y, z position in the 3D model space 400 from which the requested data is to be viewed. Such view point information may further include, but is not limited to, view direction information, screen resolution information, and the like.

As a result, when selecting the data describing the various sub-components and sub-component versions belonging to a requested sub-space, back end server may, prior to transmission of the selected data, substantially cull the data describing the first sub-component building, moderately cull, and perhaps differentially, cull the data describing parts of the second sub-component building far from the requested view point information, and cull the data forming the generator to match, for example, a screen resolution of the user interface 500 on which the data is to be viewed. In other exemplary embodiments, data may be culled base upon a viewing direction. For example, if the request indicates that the requested data will be viewed from inside the second sub-component building and looking away from first sub-component building, data forming the first sub-component building may be substantially culled or eliminated entirely.

Thus, data may be culled at back end server 208 prior to transmission in order to, for example, reduce the large volume and attendant bandwidth required to transmit the data so as to enable near real time navigation of the requested sub-space. Because the view point of a user as derived, for example, from the model space rendering 508, may change as the viewed sub-space is rotated, translated, zoomed in, zoomed out and the like, it may be desirable to periodically send updated versions of culled data forming a requested sub-space from the back end server 208. Such updates may occur as the result of a manual refresh activated by a user, such as, for example, via activating a refresh button 506 on the user interface 500. In accordance with other embodiments, a user may define, such as via the user interface 500, an automated request for updates. For example, a user may define a request be sent every 5 minutes, whenever a view point changes by a predetermined amount, whenever a viewing direction changes by a predetermined amount, whenever the user zooms in or out by a predetermined amount, and the like. It is understood that different users each collaborating on the same sub-space may at any time be viewing the same sub-space data from different locations, in different directions, at different screen resolutions, etc. In such instances, may selectively cull and transmit data to user devices collaborating in the same sub-space on a user device-by-user device basis.

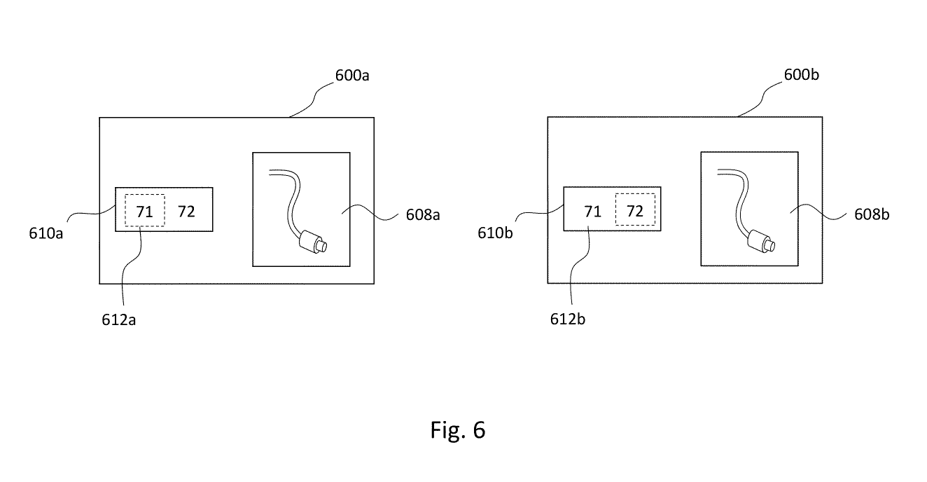

With reference to FIG. 6, there is illustrated an exemplary embodiment of a shared 3D modeling space 400. Specifically, there is illustrated a user interface 600a and a second user interface 600b appearing on the user devices 202a, 202b, respectively. In the present example, users of the user interfaces 202a, 202b are collaborating on the design of the sub-space 404b of FIG. 4 comprising sub-component 7. A user of device 202a may be accessing version 7.1 of sub-component 7 and user of device 202b may be accessing version 7.2 of sub-component 7. Note that the model space diagram 610a may have a visual indicia 612a indicating that a model space rendering 608a is drawn to version 7.1 while a model space diagram 610b has a visual indicia 612b indicating that model space rendering 608b is drawn to version 7.2. In this fashion, two users, each with authenticated access to the displayed and requested subspace 404b, may collaborate simultaneously on different versions of sub-components in a sub-space without observing any impact of the other user's actions on the sub-component.

While illustrated with reference to two users simultaneously collaborating on different versions of a sub-component in a shared sub-space 404b, it is understood that such may also collaborate on the same version of a sub-component.

As noted above, the design platform 100 enables the collaborative design by users via the user interfaces 600. In exemplary embodiments, design interaction may be facilitated via, for example, a model space rendering facility 608. In various exemplary embodiments, in addition to merely providing visualization of sub-spaces of the 3D model space 400, the model space rendering 608 may form but one part of suite of applications, including 3rd party applications, enabling analysis, manipulation and storage of sub-space data. The 3D collaborative design platform 100 does not limit the variety of third party applications that may be utilized. Because various third party applications may make use of a plurality of disparate data formats, design platform operates to manage the exchange of data in various data formats between back end server 208 and 3D design applications through which collaborating users may be collaborating in the design and augmentation of the sub-space 404 data.

In accordance with exemplary and non-liming embodiments, the back end server 208 retrieves requested sub-space 404 data from the 3D model space 400 and proceeds to translate the requested data from a source data format to a target data format matching that of the 3D design application on which the requested sub-space 404 data is to be viewed and manipulated. In such instances, the request from the user device 100 may include information indicative of the target data format or information indicative of the 3D design application to be used and from which a target data format may be derived.

Conversely, when a user wishes to save changes made to one or more sub-components of a sub-space 404, the changed and/or new versions of each sub-component is received by the back end server 208 and translated from the target data format back into the source data format before re-integration with the 3D model space 400. In this manner, users are able to collaborate on the design of sub-spaces using design applications with which they are familiar whether or not their fellow collaborators are using the same design application.

In accordance with various exemplary and non-limiting embodiments, the back end server 208, upon receiving a request to save a sub-space or portion of a sub-space from one or more authenticated collaborative users, proceeds to determine which sub-components, if any, of the sub-space 404 have been changed or are new. For example, if alterations have been made to subcomponent 7.1 of FIG. 4, the newly altered version may be stored as new version sub-component 7.3. In other exemplary embodiments, sub-components may have been added to the portion of the hierarchical 3D model space 400 comprising sub-space 404. For example, sub-component 7 of sub-space 404b may now branch to a newly created sub-component 8. In such an instance, back end server 208 operates to integrate new sub-component 8 with the 3D model space 400.

In accordance with an exemplary embodiment, user authorization and access to the 3D model space 400 may be accorded on any level of granularity including, but not limited to, 3D Model Space level, component level, sub-component level, sub-space level and the like. As a result, access to various portions of 3D model space may be controlled as desired.

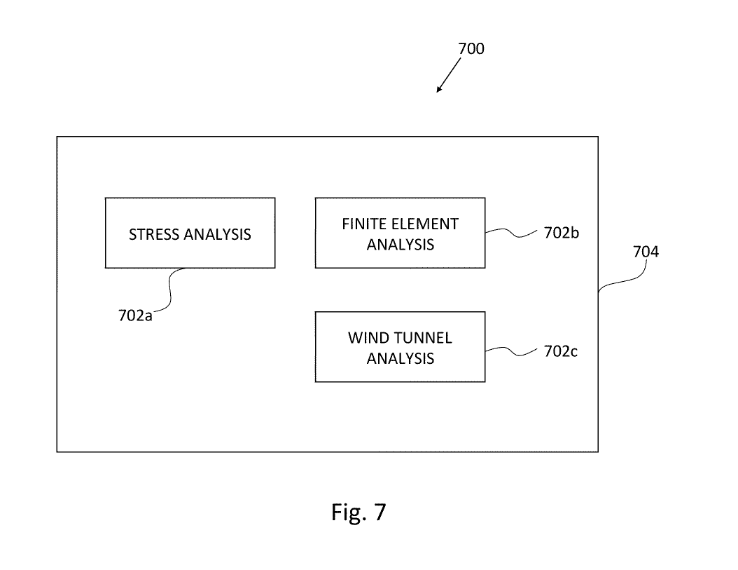

With reference to FIG. 7, there is illustrated an exemplary embodiment of an app store 700 for providing access to quantifiable applications that may be performed on the 3D model space 400. As illustrated, the app store 700 is displayed on a user interface 704 comprising a plurality of exemplary and non-limiting applications 702a-c including, but not limited to, stress analysis 702a, finite element analysis 702b, and wind tunnel analysis 702c.

The app store 700 provides access to applications that perform desired actions upon portions of a 3D model space 400 to which a user has authenticated access on a, for example, pay-per-use basis. For example, a user may have authenticated access to a component airplane in the 3D model space 400. The user may further wish to perform wind tunnel analysis on the component airplane but may not have access to a utility or application capable of performing wind tunnel analysis. In such an instance, a user or collaborating users may request, such as by activating or otherwise selecting the wind tunnel analysis app 702c on the user interface 704, that wind tunnel analysis of the component airplane be performed by the back end server 208 with the results streamed or otherwise sent to the requesting user for review.

Upon receipt of the request for wind tunnel analysis, back end server may operate to authenticate the requesting user's access to the portion of 3D model space to be analyzed and transmit requests for additional information, such a wind flow parameters, flight conditions, etc. Upon receiving from the user the additional information, the back end server 208 proceeds to invoke the requested application using the received application parameters and to transmit the results to the requesting user or users.

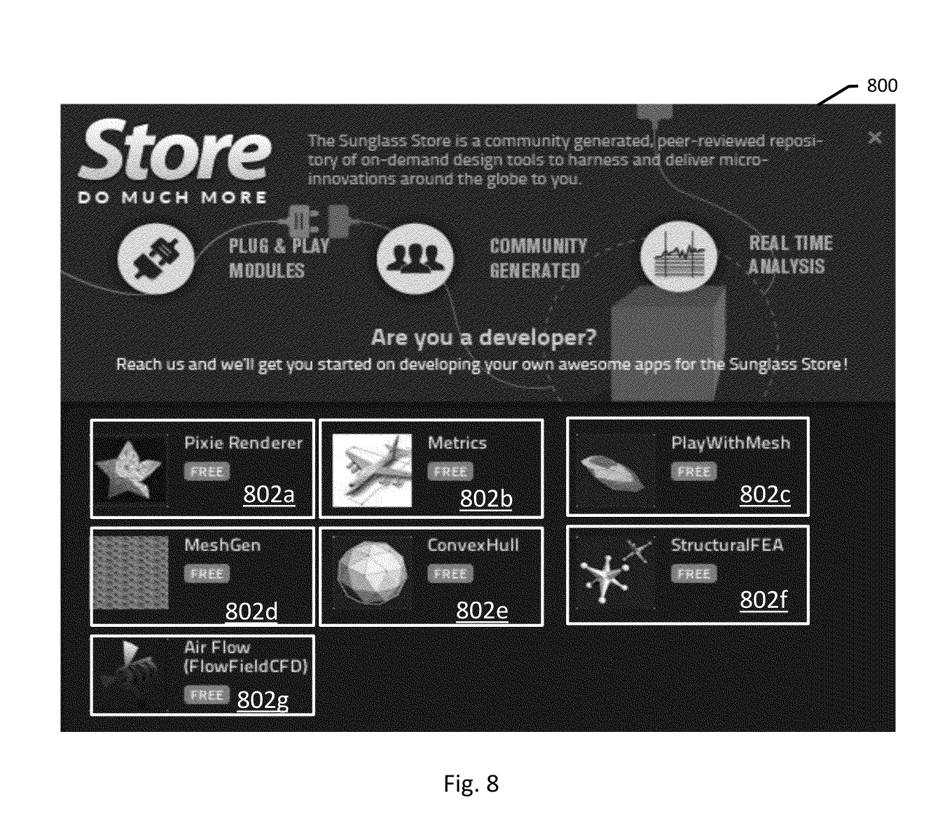

With reference to FIG. 8, a screen shot of an exemplary application store interface 800 is depicted. This interface provides a list of app store applications—community generated, peer-reviewed repository of on-demand design tools to harness and deliver micro-inventions around the globe. The app store interface 800 may comprise a plurality of exemplary and non-limiting applications 802a-g including, but not limited to, pixie renderer 802a, metrics 802b, play with mesh 802c, mesh gen 802d, convex hull 802e, structural FEA 802f, and airflow 802g. As shown in the FIG. 8, the users or collaborating users may access these applications on a trail basis, free or pay per usage basis. Once the user or the collaborating users are authenticated to access these applications, the app store interface 800 may allow the user to access these applications such as to perform real time analysis or processing operations on the 3D model space 400. In the present example, the user may select the pixie renderer 802a to perform rendering on components, sub space or 3D model space 400. The pixie renderer 802a may use RenderMan implementation to return ray-traced images of your scene. In an example, the user or the collaborating users may access the mesh related applications such as play with mesh 802c and mesh gen 802d such as to process mesh parameters on the 3D model space 400. In another example, the users or collaborating users may access the structural FEA 802f such as to perform finite element analysis (FEA) on one or more structures of the 3D model space 400. The FEA analysis may assist in correcting the design specifications of the structures prior to manufacturing or construction. In an example, the user or collaborating users may access the airflow 802g to automate computational fluid dynamics (CFD) process such as to analyze the low speed, incompressible flow of air around 3D structures. The airflow 802g may automatically take care of mesh preparation, solution and post processing steps so that even a first time user may perform complex CFD simulations on the 3D structures in a real time collaborating environment. On selection of the one or more applications 802, the design platform 100 may instruct the back end server 208 to execute the instructions and provide the results of the real time simulations to the users or the collaborating users.

In an embodiment, an API may provide shared workspaces, comprising, for example, one or more sub-spaces, that may facilitate real-time analysis. The API may enable concurrent design, multiple analysis and modeling processes, plug and play modules, and the like by more than one user on one or more client devices 202. The API may provide a collaborative ecosystem, facilitate in procedural modeling, workflow management, and the like. The API may also enable creation of content in design analysis and optimization, knowledge/decision management, and accelerated assembly/procedural generation and visualization. The API may simplify file management by enabling a distributed version control system for 3D model space 400 and associated workspace information.

In accordance with various exemplary and non-limiting embodiments, the real-time collaborative design platform 100 democratizes access to high performance tools. The design platform 100 enables designers and state of the art research laboratories to achieve a larger footprint for their design and analysis tools. A delivery mechanism is provided that may achieve low barriers to access, harnesses a global community of users and developers, and may enable seamless interdisciplinary collaboration. The design platform 100 responds to these challenges by casting a CAD architecture into a networked platform for real-time collaboration. This architecture may significantly speed up and may support creativity in the early design phase enabling rapid design iterations, complex analysis, real-time analytics and centralized workflow management in a collaborative setting.

Also, the design platform 100 may facilitate designers/users to achieve greater reach, access immediate feedback and influence a global community of users by creating and sharing applications addressing the demanding design challenges. Likewise, the design platform 100 may be used in applications such as increasing impact through energy simulation and optimization, and achieving higher performance in complex design.

The platform developed in the present invention may provide real-time collaboration. It may also provide a choice of applications to users to create content in design analysis and optimization, knowledge/decision management, and accelerated assembly/procedural generation. Further, the platform may provide a file management system by enabling distributed version control of a master 3D model to support clone, fork, compare, merge, and the like. Additionally, the platform may provide a pay-per-use model that may enable the users to create, consume, and share designs and design applications.

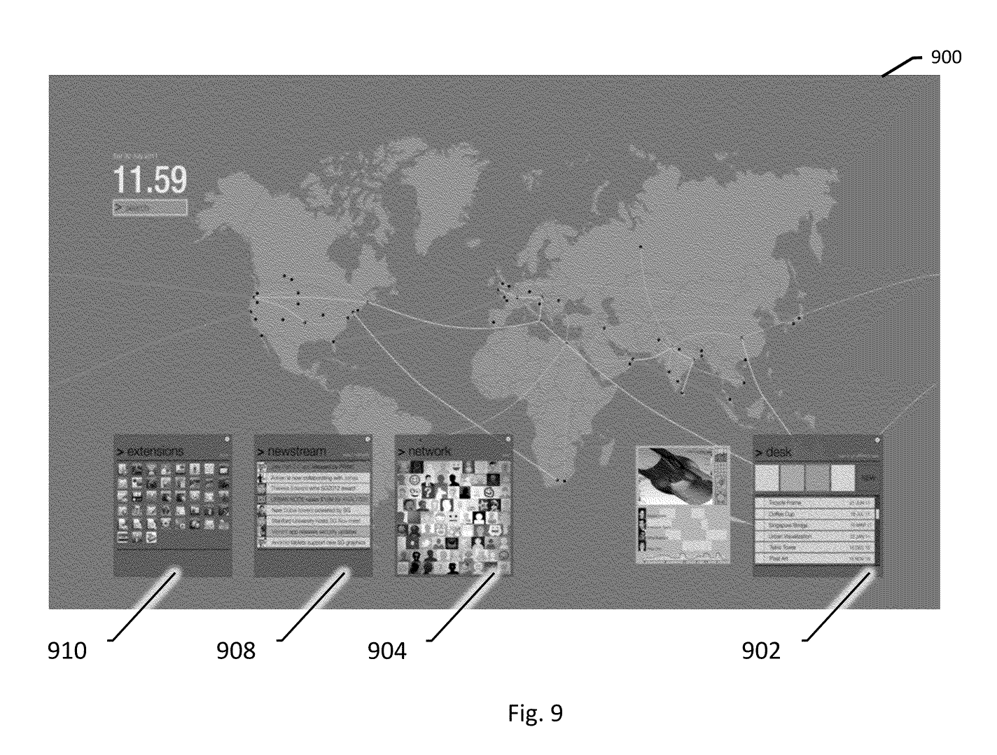

With reference to FIG. 9, there is illustrated an exemplary and non-limiting embodiment of a user interface 900 comprising a login screen that a user may view while accessing design platform 100 such as via a user device. The user interface 900 operates as a point of entry for the user. The user interface 900 may also be delivered via the Internet to a user at a user device and may include the world map as a background that may be overlaid with the network of users, developers, projects, and the like. Once the user logs in to the design platform 100, such as by providing authentication information, a Desk widget 902, a Network widget 904, a Newstream widget 908, and Extensions 910 of the user interface 900 may become active.

The desk widget 902 may be a collection of projects, each project comprising at least on the 3D model space 400 or portion thereof, that the user may own, subscribe to, or otherwise have authenticated access to. The projects may be shared resources and multiple users may subscribe to a single project and synchronously edit/view sub-spaces of the project based on access privileges as described above. The users may click/hover over subscribed/public projects to check which other users are collaborating. Further, the users may check project activities, both user specific and global, on a timeline. The shared sub-spaces may enable the users to check the applications that may be used. In an embodiment, the Desk widget may allow an authorized user to choose and expand a project to start editing/viewing.

The design platform 100 works cooperatively with various networking approaches including social-type networks. Each user may have a list of other (trusted) users who co-share projects. The network widget 904 may enable a user to browse through all information that the user's collaborators may have made public such as their geographical location. Further, the users may view who they are working with such as 2nd degree collaborators. The network widget 904 may also enable users to get information about the applications that they are using, all public projects across the network, and the like. In addition, users may also send messages/notifications and may share projects with users to which they are connected, such as through a social-type network.

The Newstream widget 908 may provide updates from the design platform 100, users, developers, entrepreneurs, and the like. The users, developers, entrepreneurs, sponsors, tools vendors, and others may publish tweet-like messages over several channels. Further, users may choose to follow certain channels of interest.

Extensions 910 of the design platform 100 may provide users with a list of applications to which they may have subscribed and/or purchased. The users may check for updates, competing applications, add/remove applications, check usage details, and the like. Further, the users may use a subset/combination of the list in their design projects.

As mentioned herein, projects comprised of one or more 3D model spaces 400, or “project spaces”, form a core unit of the design platform 100. Project sub-spaces may include project information such as geometry, scene graph (also called the stage tree), project metadata, historical timeline and version data, collaborator data, project data, and the like. Further, project spaces may include computation app modules that may generate/modify/analyze/transport design information. Apps may be modular applications that run on top of a stage. User changes/viewership details regarding any aspect of project spaces may be logged on a timeline corresponding to one or more project spaces. In an embodiment, the project spaces provide solutions to a plurality of issues such as design concurrency and coherence. The users subscribing to a project space may receive synchronously updates of all changes (e.g. over a network, or via the Internet). Also, all changes made by the users may get synchronously updated in the 3D model space 400 associated with a project space as described above.

As described above, version selection of sub-components may be performed by a user via a manual process. In an exemplary and non-limiting embodiment, design platform 100 supports presenting at least two versions of a part/3D model so that an owner can select one which results in a selection of one of the version branches. An user may apply various comparison and analysis tools to the at least two versions to determine differences. An user may also perform assembly of any of the versions of a sub-component into a higher level assembly and check results (e.g. fit, and the like) to help decide which branch (e.g. which sub-component) to select for merging.—A user can also identify a criteria (ex; minimum volume, surface, target surface area for a logo, or any other aspect) to be used to identify a sub-component/3D model space 400/sub-space/branch to follow/merge. In an exemplary embodiment, geometry may be analyzed (e.g. perform computations on the geometry) to see how it complies with other sub-components.

In accordance with alternative exemplary embodiments, conventional part compatibility testing capabilities may be applied to facilitate determining which branch to follow. Similarly, meta data for each version of a sub-component (e.g. material, price, computation of price based on the material, and other types of part metadata) may be examined, analyzed, or compared to determine how an assembly of sub-components based, at least in part, on the sub-component version matches to a criteria. In an example, it may be possible to determine (e.g. calculate) a cost for each version of a sub-component and generate a higher level cost for various versions of a sub-component when applied to a 3D models space 400 or sub-space. Versions of sub-components as described herein and elsewhere may also be treated as design options because each version of a subcomponent is maintained by design platform 100 in a distributed version control system that is much more than a change history record. Therefore, version control facilities of the distributed 3D design platform 100 facilitate automated assistance for selecting branches for merging. Each of these elements may provide support for generalized distributed version control of 3D models.

Further, the applications enabling user interfaces on the user devices, 202, the front end server 204, an/or the back end server 208 may broadcast changes/computations to sub-components and sub-spaces in real-time or near real time streams. In an exemplary embodiment, buffering technologies may be used to streamline user experience. Sub-spaces may maintain coherency due to the real-time streaming and shared editing features. The coherence may be maintained algorithmically (e.g., smart compare and merge/thread locks) to prevent data corruption. While the same design sub-space may be shared by multiple users, each sub-space may have its own set of extensions/application/representation-schemes to describe a design model. For example, a structural engineer may be interested in stress strain and structural analysis, whereas a daylight engineer may be interested in Lux level calculations. They may share the same sub-space but individually they may have completely different representations of the shared sub-space forming a portion of 3D model space.

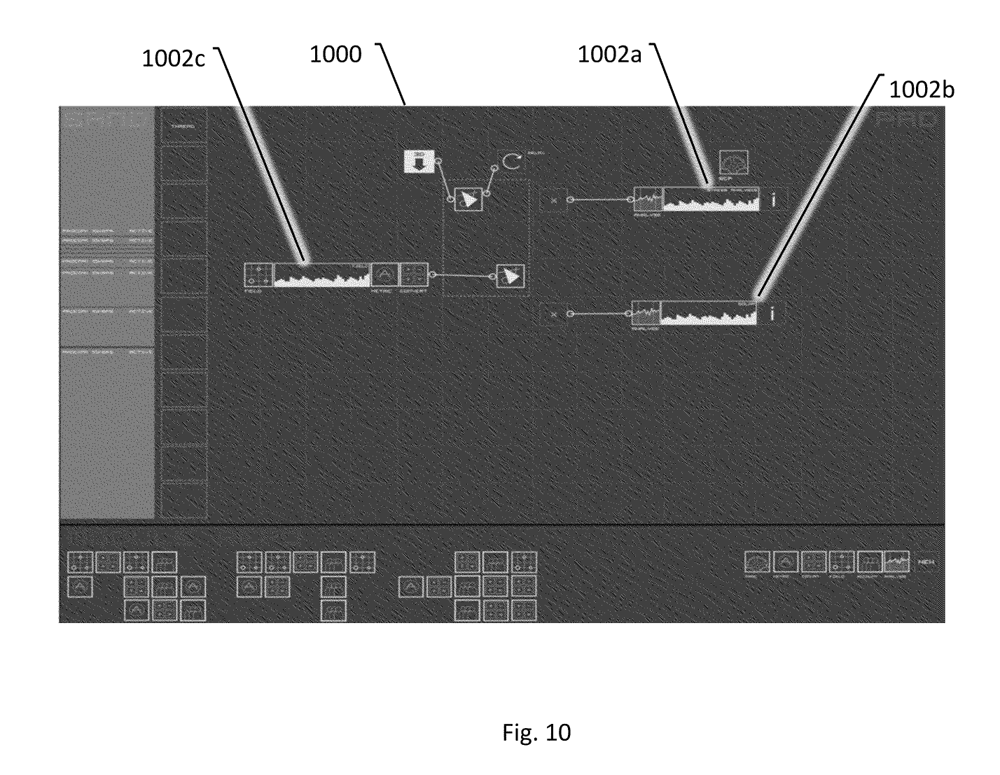

With reference to FIG. 10, there is illustrated a snapshot of a user interface 1000 of a sub-space of the design platform 100, in accordance with an embodiment. The user interface 1000 forms a Process Pad. The user interface 1000 may be used for visually laying out all the computational processes in a circuit like diagram. Each node 1002, collectively forming a “circuit”, may be a process, which may be hosted in the backend server 208. Some of these processes may run only once at the start during setup (e.g. a 3D model space/sub-space import) and some may be run continuously (e.g. an analysis node) with a frequency assigned to them. These processes may or may not be inter-dependent i.e. they may be started/stopped without affecting the computations happening elsewhere in the circuit.

The user interface 1000 may provide multiple processes, asynchronous processing, multiple frequencies of processing, (e.g., one node may run at 1 cycle/sec, another might run at 50 cycles/sec, and the like), and the like. The design platform 100 may focus on conditions of formation such as process orientation rather than on geometric form such as object orientation. The circuit may be more powerful and may accommodate cyclic loops unlike other CAD systems which may have their object-process architecture modeled as directed acyclic graphs. In addition, all computation nodes may be hosted in the backend multi-cluster servers 208.

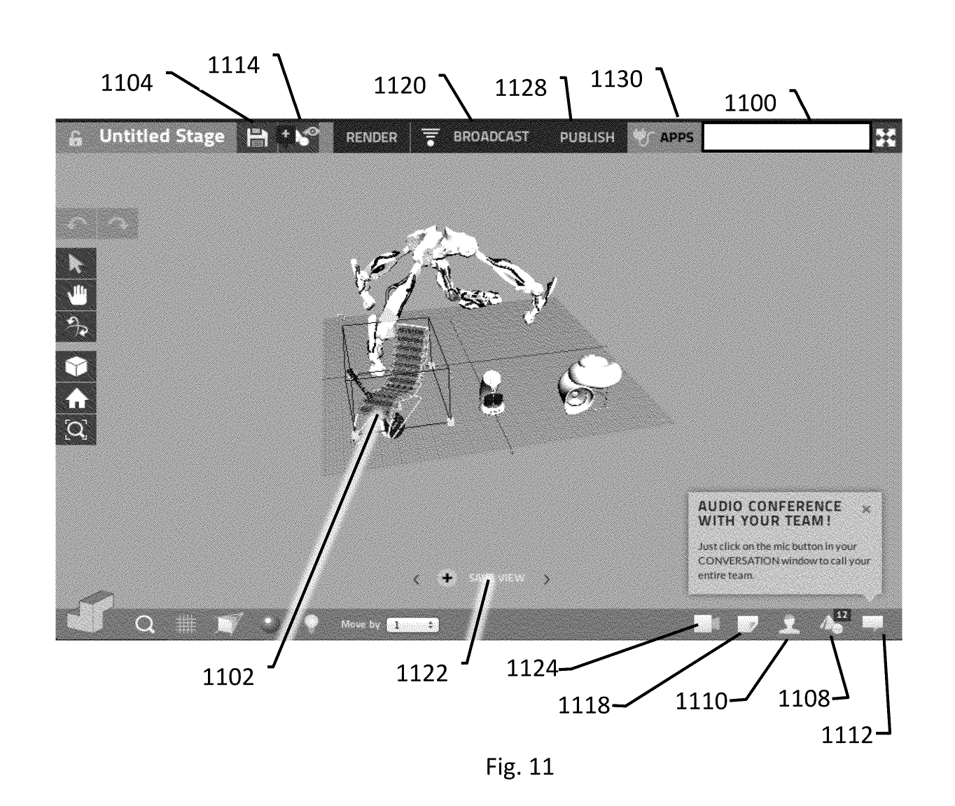

With reference to FIG. 11, there is illustrated a user interface 1100 according to exemplary and non-limiting embodiments. In the present example, a couple of sub-components 1102 are selected (chair back and chair seat). Features of a user interface 1100 include file access 1104, 3D modeling 1108, collaborators 1110, messaging 1112, notes 1114, note manager 1118, broadcast 1120, saving views 1122, view manager 1124, publishing 1128, and applications 1130. The file access 1104 feature may include drop and drag support for uploading a variety of models including, but not limited to: 3DS, OBJ, STL, Blend, DAE, SolidWorks, Autodesk Inventor, CAITA, Creo, I-deas, IGES/STEP, IFC, JT, Parasolid, PRC, Pro/Engineer, Siemens PLM/NX, Solid Edge, VDA-FS and VRML models. 3D modeling may include access to a user's 3D models in an objects panel through which objects can be added and/or downloaded.

Collaborators 1110 may support inviting collaborating users and determining which users and/or collaborators are currently available. Messaging 1112 may facilitate communicating by message with any other member(s) of a design team. Notes capability 1114 may facilitate creating and “pinning” notes on presented sub-spaces. Notes capability may include adding images as sub-component/sub-space attributes that may be annotated with text or interactive sketching. Notes manager 1118 may facilitate viewing all notes in one place (rather than needing to access each sub-space separately) as well as creating an HTML summary of all notes created in a particular stage, no matter who created them.

Broadcasting 1120 may allow a user to broadcast a particular scene or sub-space rendering to collaborating users in near real time and let the users synch up their scenes post broadcasting. Saving views 1124 may facilitate saving views as presented in the work area of the user interface 1100 that may later be used to created an animated showcase of views. A view manager 1124 may facilitate viewing and managing saved camera views and to support adding captions to individual saved views. A publishing facility 1128 may facilitate providing a showcase of work for access by users of other websites. The publishing feature 1128 may facilitate generating a “player” and embedding this player in other websites for accessing remote viewing functionality. Applications 1130 may facilitate adding applications to a sub-space while running the added applications on cloud computing resources rather than on a client computer such as the user device 202.

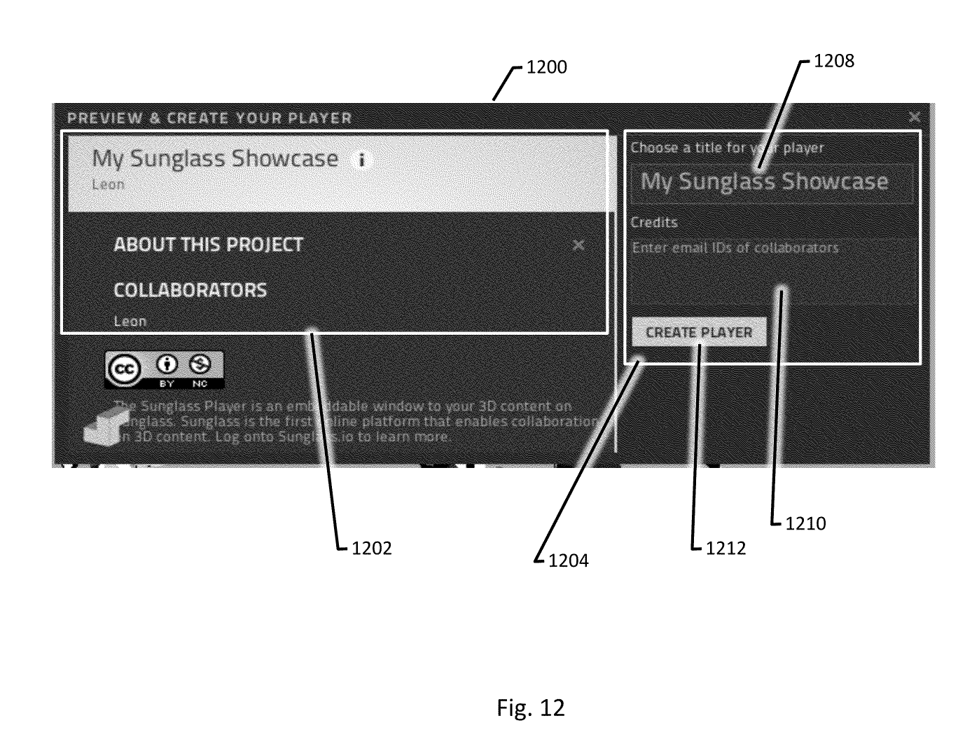

With reference to FIG. 12, a broadcast interface 1200 may facilitate the broadcasting 1120 capability of the platform 100 to create and maintain a showcase. Features of the broadcast interface 1200 may include preview space 1202 and creation space 1204. The creation space 1204 may include title 1208, credit 1210 and create player 1212. The user may select the title 1208 to enter details of the title for the showcase. In the present example, user inputs “My Sunglass Showcase” as the title of the showcase. The user may edit the credit 1210 to add details such as email contacts of the collaborators that may have collaborated in generating the one or more stages of the showcase. As the user enters the details in the title 1208 and credit 1210, the preview space 1202 may display the added details in the same manner as the details will be displayed after the creation of the showcase. The user may select the create player 1212 such to complete the showcase creation. In an exemplary embodiment, the player thus created may allow users to embed and view 3D content on the web. The user may select the one or more stages that are required to be embedded for the player. The user may copy the embedded link and provide the links within a HTML page in which the user may want to embed the player. In an exemplary embodiment, whenever the user may edit or insert a change such as a change in geometry of a model, this change may be automatically updated in the published player.

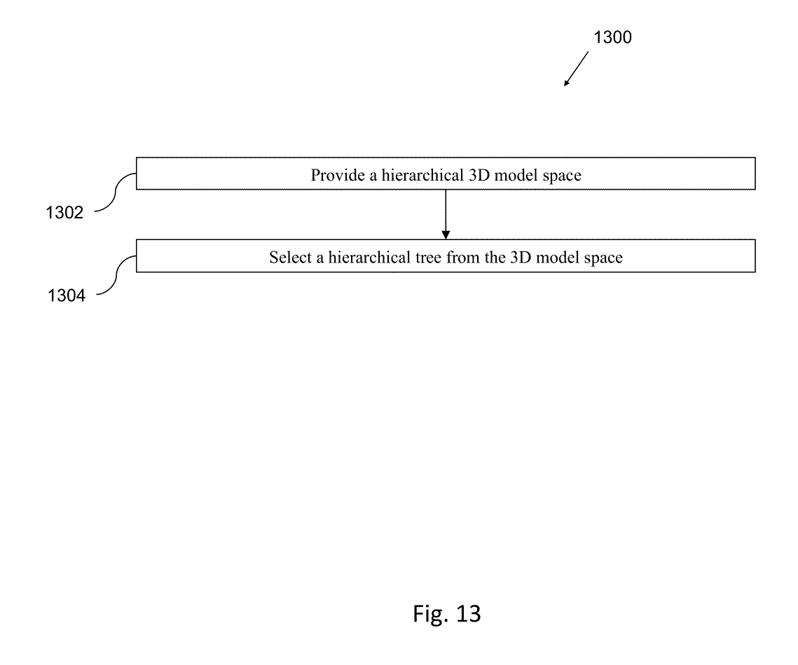

FIG. 13 depicts a flow chart of a method 1300 for selecting a version of a sub-component based on an attribute associated with the subcomponent. At 1302, the method 1300 may provide a hierarchical 3D model space. The 3D model space may include a plurality of nodes 402 and at least one branch from the one or more branches 408. Each node may include at least one version of a sub-component and each of the at least one version may include one or more attributes. At 1304, the method 1300 may select a hierarchical tree from the 3D model space that may include a plurality of the plurality of nodes and at least one of the at least one branch. Each of the plurality of the plurality of nodes may include a single version of a sub-component selected, based, at least in part, upon at least one of the one or more attributes associated with the sub-component. For example, different versions of sub-components may be selected for inclusion in forming the component based on various factors. For example, as noted above, versions of sub-components may be tagged with attributes such as price, cost, license status/clearance, strength, stress/strain, weight, material properties, geometry and the like. Some attributes such as, for example, price, may be entered by a user, such as via a user interface of the user device 202, while other attributes such as, for example, geometry, may be computed by the platform 100.

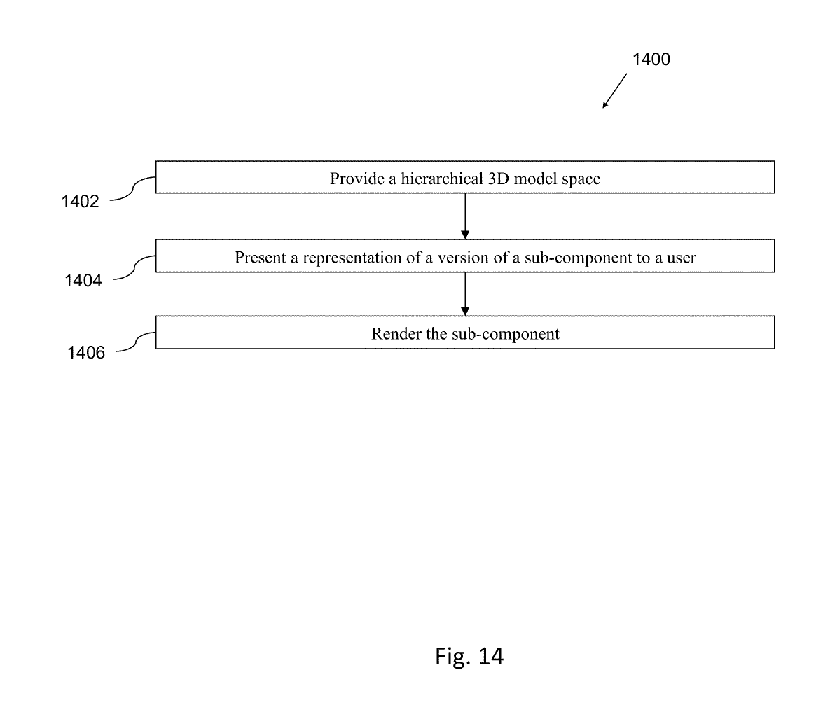

FIG. 14 depicts a flow chart of a method 1400 for rendering a version of a sub-component in response to a user selection. At 1402, the method 1400 may provide a hierarchical 3D model space. The 3D model space may include a plurality of nodes 402 and at least one branch from the one or more branches 408. Each node may include at least one version of a sub-component and each of the at least one version may include one or more attributes. At 1404, the method may present to a user a representation of each of the at least one version of a sub-component. The user may select one of the at least one version of the sub-component. At 1406, the method 1400 may render the sub-component in the 3D model space.

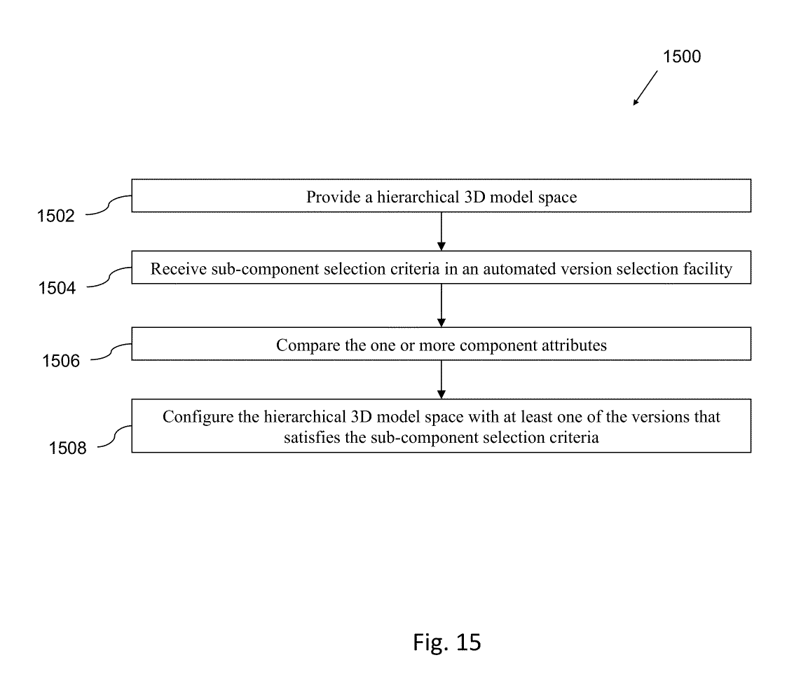

FIG. 15 depicts a flow chart of a method 1500 for automatically determining a version of a sub-component in response to selection criteria. At 1502, the method 1500 may provide a hierarchical 3D model space. The 3D model space may include a plurality of nodes 402 and at least one branch from the one or more branches 408. Each node may include at least one version of a sub-component and each of the at least one version may include one or more attributes. At 1504, the method may receive sub-component selection criteria in an automated version selection facility. At 1506, the method 1500 may compare the one or more component attributes for each of the plurality of versions of the sub-component to determine at least one version of the plurality of versions that satisfies the sub-component selection criteria. At 1508, the method 1500 may configure the hierarchical 3D model space with at least one of the versions that satisfies the sub-component selection criteria.

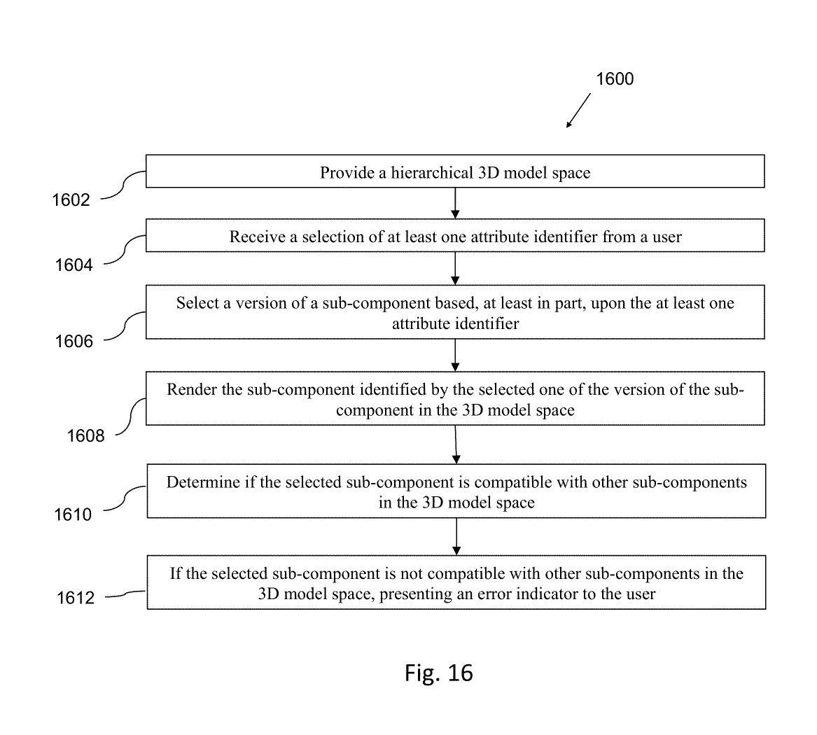

FIG. 16 depicts a flow chart of a method 1600 for rendering the sub-component in a 3D model space. At 1602, the method 1600 may provide a hierarchical 3D model space. The 3D model space may include a plurality of nodes 402 and at least one branch from the one or more branches 408. Each node may include at least one version of a sub-component and each of the at least one version may include one or more attributes. At 1604, the method 1600 may receive a selection of at least one attribute identifier from a user. At 1606, the method 1600 may select a version of a sub-component based, at least in part, upon the at least one attribute identifier. At 1608, the method 1600 may render the sub-component identified by the selected one of the version of the sub-component in the 3D model space in response to the selecting one of the at least one version of the sub-component. Optionally, at 1610, the method 1600 may determine if the selected sub-component is compatible with other sub-components in the 3D model space or not. At 1612, the method 1600 may present an error indicator to the user when the selected sub-component is not compatible with other sub-components in the 3D model space.

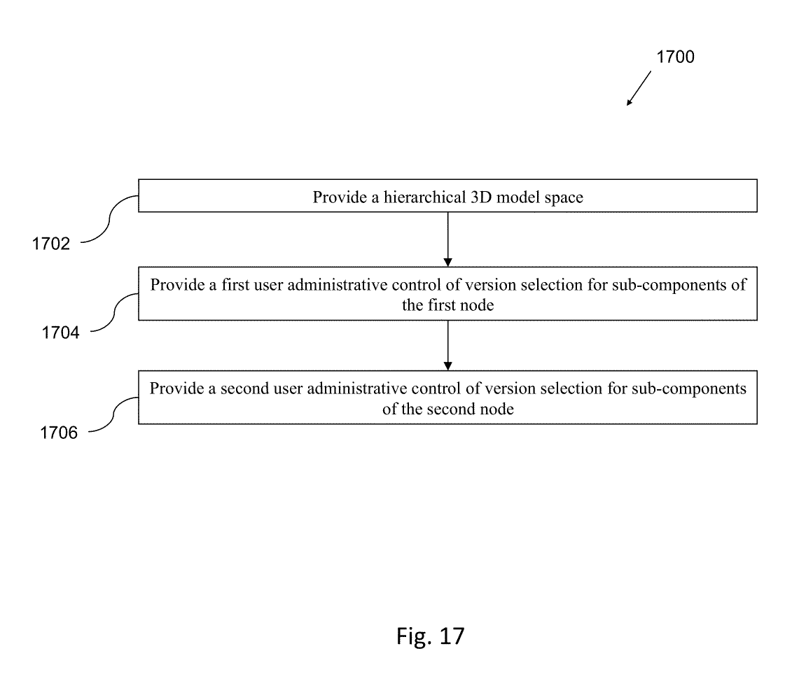

FIG. 17 depicts a flow chart of a method 1700 for providing a distributed version control. At 1702, the method 1700 may provide a hierarchical 3D model space. The 3D model space may include a plurality of nodes 402 and at least one branch from the one or more branches 408. Each node may include at least one version of a sub-component and each of the at least one version may include one or more attributes. At 1704, the method 1700 may provide a first user administrative control of version selection for sub-components of the first node. At 1706, the method 1700 may provide a second user administrative control of version selection for sub-components of the second node.

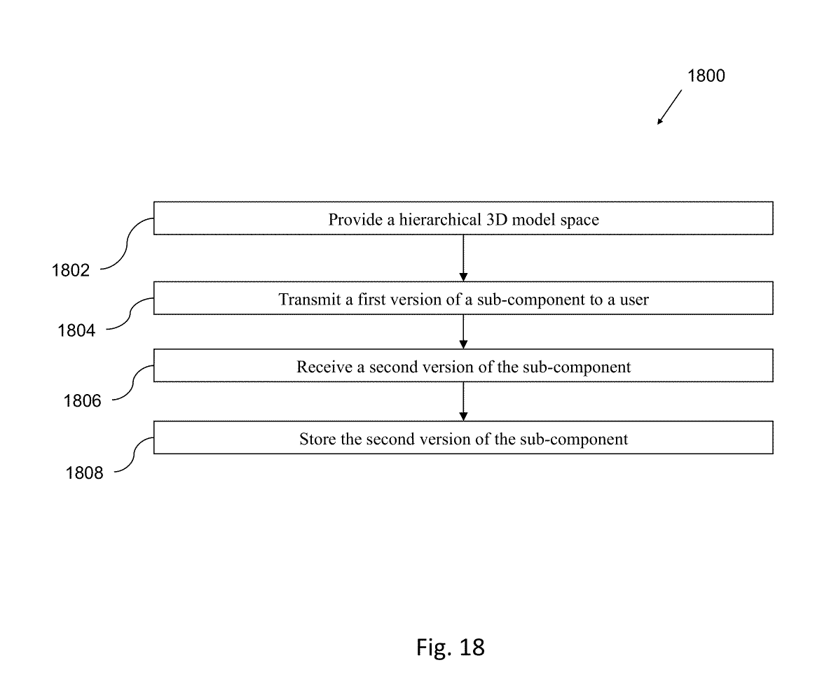

FIG. 18 depicts a flow chart of a method 1800 for storing an updated version of a sub-component. At 1802, the method 1800 may provide a hierarchical 3D model space. The 3D model space may include a plurality of nodes 402 and at least one branch from the one or more branches 408. Each node may include at least one version of a sub-component and each of the at least one version may include one or more attributes. At 1804, the method may transmit first version of a sub-component to a user. At 1806, the method 1806 may receive a second version of the sub-component comprising an updated version of the first version from the user. At 1808, the method 1800 may store the second version of the sub-component in the 3D model space associated with the same node as the first version of the sub-component.

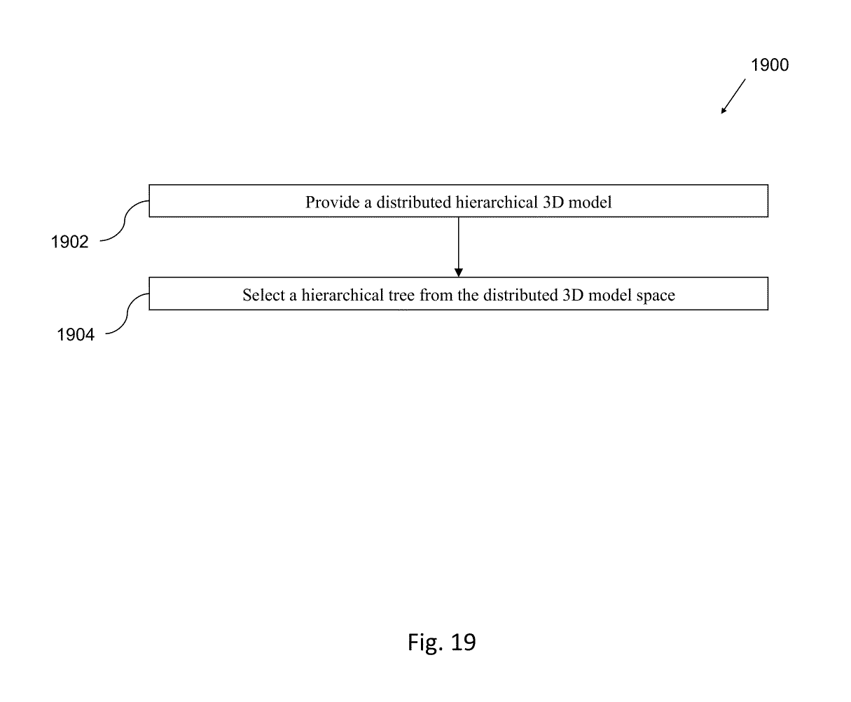

FIG. 19 depicts a flow chart of a method 1900 for selecting a hierarchical tree from a distributed 3D model space. At 1902, the method 1900 may provide a distributed hierarchical 3D model space. The 3D model space may include a plurality of nodes and at least one branch. Each node may include at least one version of a sub-component and each of the at least one version may include one or more attributes. At 1904, the method 1900 may select a hierarchical tree from the distributed 3D model space. The selected distributed 3D space may include at least one branch and each node that may include a single version of a sub-component selected, based, at least in part, upon at least one of the attributes associated with the sub-component.

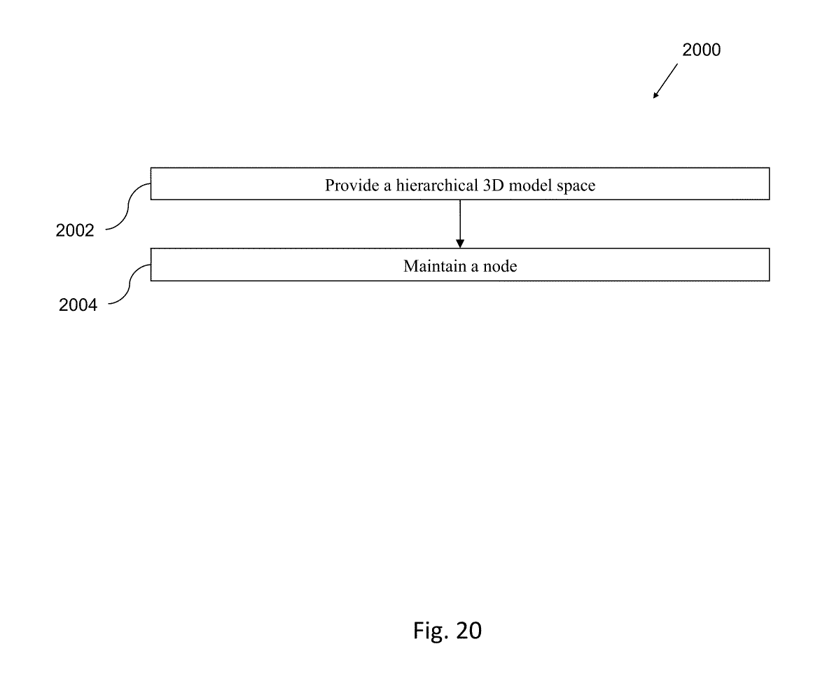

FIG. 20 depicts a flow chart of a method 2000 for maintaining a node of a 3D model space. At 2002, the method 2000 may provide a hierarchical 3D model space. The 3D model space may include a plurality of nodes 402 and at least one branch from the one or more branches 408. Each node may include at least one version of a sub-component and each of the at least one version may include one or more attributes. At 2004, the method 2000 may maintain a node comprising a plurality of versions of a sub-component at a terminus of the at least one branch.

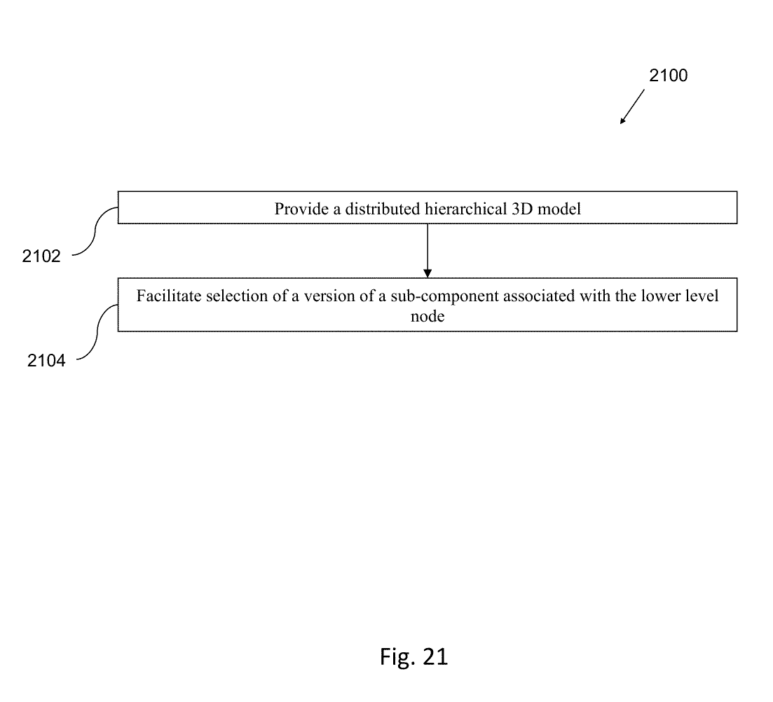

FIG. 21 depicts a flow chart of a method 2100 for managing hierarchical version in distributed 3d modeling space. At 2102, the method 2100 may provide a distributed hierarchical 3D model space for collaboration among a plurality of users. The model space may include a plurality of nodes and at least one node is at a lower level in a hierarchy than at least one other node. Each node may include at least one version of a sub-component. At step 2104, the method 2100 may facilitate selection of a version of a sub-component associated with the lower level node. The selected version is may integrate with one or more versions of a sub-component of the other node in the 3D model space.

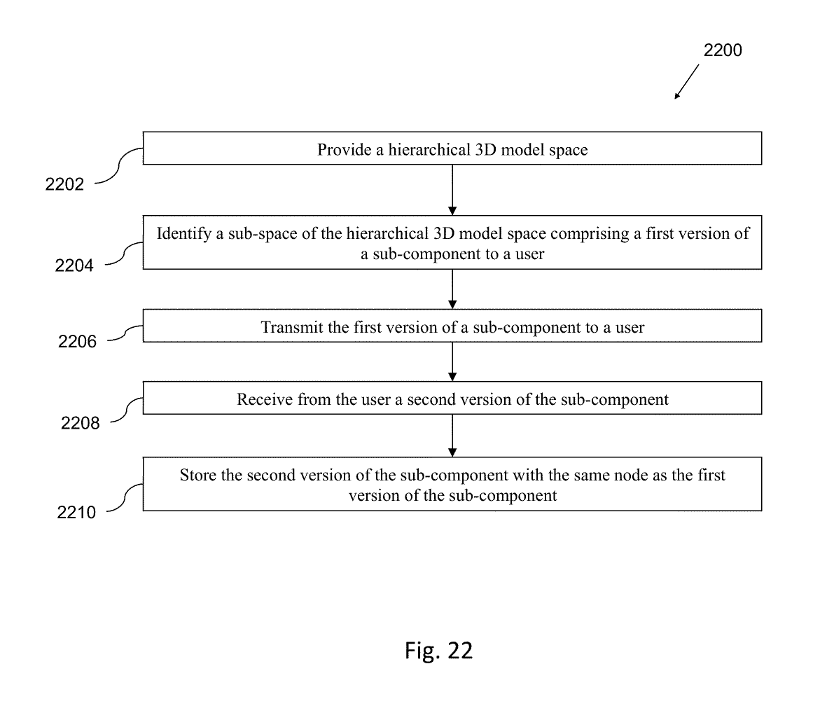

FIG. 22 depicts a flow chart of a method 2200 for storing different versions of a sub-component in a same node. At 2202, the method 2200 may provide a hierarchical 3D model space. The 3D model space may include a plurality of nodes 402 and at least one branch from the one or more branches 408. Each node may include at least one version of a sub-component and each of the at least one version may include one or more attributes. At 2204, the method 2200 may identify a sub-space of the hierarchical 3D model space comprising a first version of a sub-component to a user. At 2206, the method 2200 may transmit the first version of a sub-component to a user. At 2208, the method 2200 may receive from the user a second version of the sub-component comprising an updated version of the first version. At 2210, the method 2200 may store the second version of the sub-component in the 3D model space associated with the same node as the first version of the sub-component.

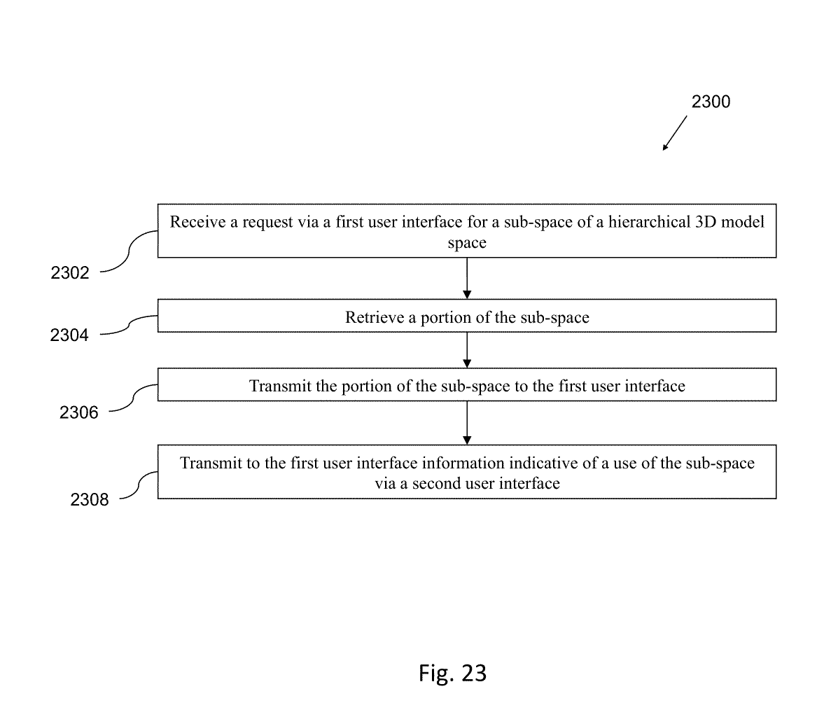

FIG. 23 depicts a flow chart of a method 2300 for transmitting information indicative of a use of the sub-space in the 3D model space. At 2302, the method 2300 may receive a request via a first user interface for a sub-space of a hierarchical 3D model space. The 3D model space may include a plurality of nodes and at least one branch. Each node may include at least one version of a sub-component. At 2304, the method 2300 may retrieve a portion of the sub-space. At 2306, the method 2300 may transmit the portion of the sub-space to the first user interface. At 2308, the method 2300 may transmit to the first user interface information indicative of a use of the sub-space via a second user interface.

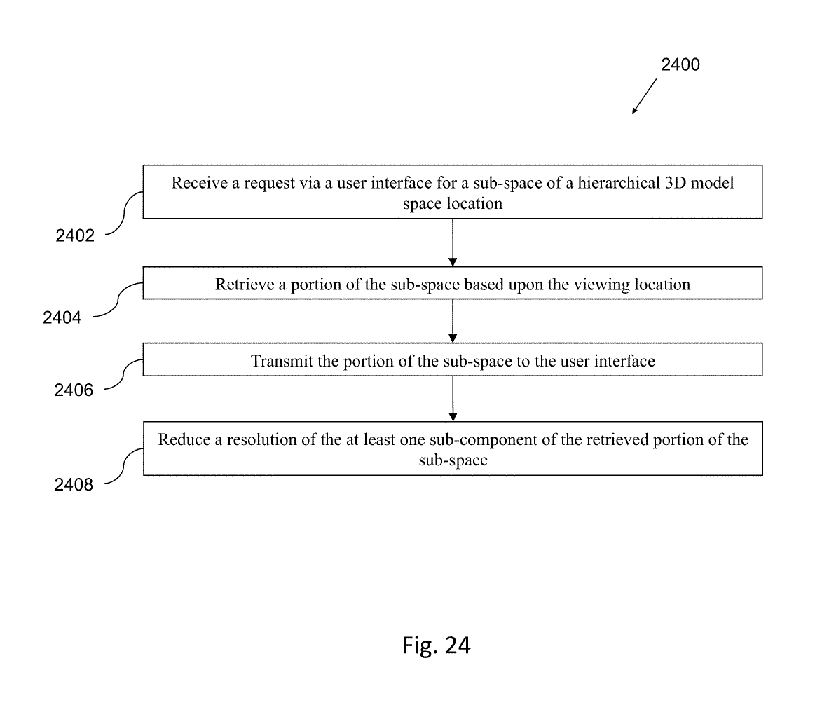

FIG. 24 depicts a flow chart of a method 2400 for transmitting a portion of a sub-space to a user interface. At 2402, the method 2400 may receive a request via a user interface for a sub-space of a hierarchical 3D model space. The 3D model space may include a plurality of nodes and at least one branch. Each node may include at least one version of a sub-component and the request may include a viewing location. At 2404, the method 2400 may retrieve a portion of the sub-space based, at least in part, upon the viewing location. At 2406, the method 2400 may transmit the portion of the sub-space to the user interface. Optionally, at 2408, the method 2400 may reduce a resolution of the at least one sub-component of the retrieved portion of the sub-space.

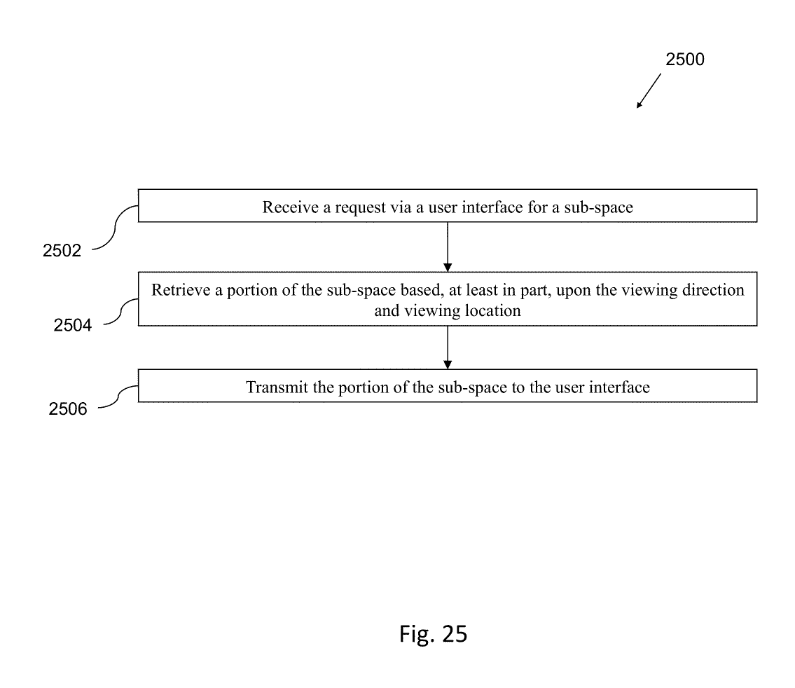

FIG. 25 depicts a flow chart of a method 2500 for retrieving a portion of a sub-space based upon a viewing direction and viewing location. At 2502, the method 2500 may receive a request via a user interface for a sub-space of a hierarchical 3D model space. The 3D model space may include a plurality of nodes and at least one branch. Each node may include at least one version of a sub-component and the request may include a viewing location and a viewing direction. At 2504, the method 2500 may retrieve a portion of the sub-space based, at least in part, upon the viewing direction and viewing location. At 2506, the method 2500 may transmit the portion of the sub-space to the user interface.

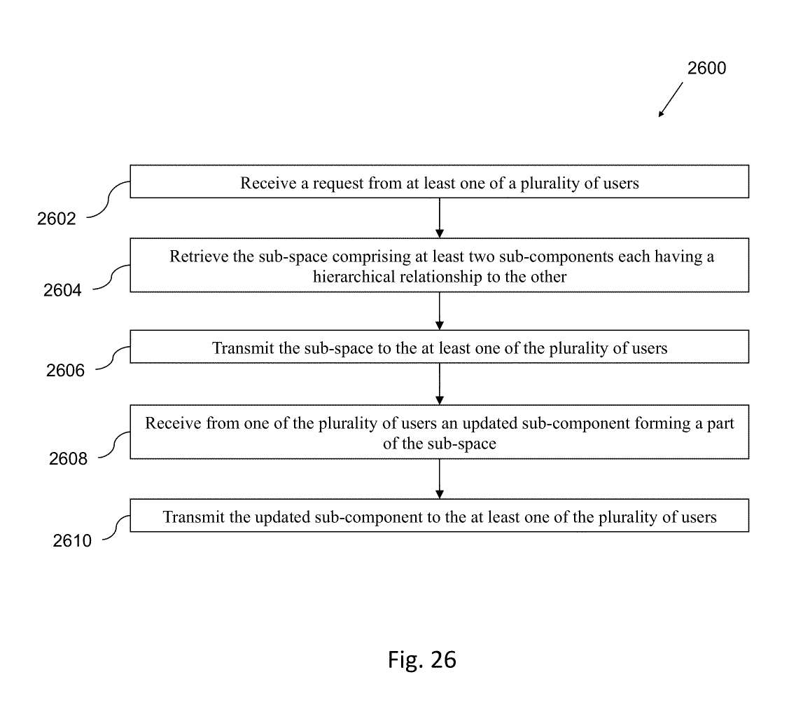

FIG. 26 depicts a flow chart of a method 2600 for transmitting a sub-space including at least two sub-components having a hierarchical relationship. At 2602, the method 2600 may receive a request from at least one of a plurality of users. Each user may have access to a sub-space of a hierarchical 3D model space that may include a plurality of nodes and at least one branch. Each node may include at least one version of a sub-component. At 2604, the method 2600 may retrieve the sub-space that may include at least two sub-components. Each of the retrieved sub-components may have a hierarchical relationship to the other. At 2606, the method 2600 may transmit the sub-space to the at least one of the plurality of users. Optionally, at 2608, the method 2600 may receive from one of the plurality of users an updated sub-component forming a part of the sub-space. Optionally, at 2610, the method 2600 may transmit the updated sub-component to the at least one of the plurality of users.

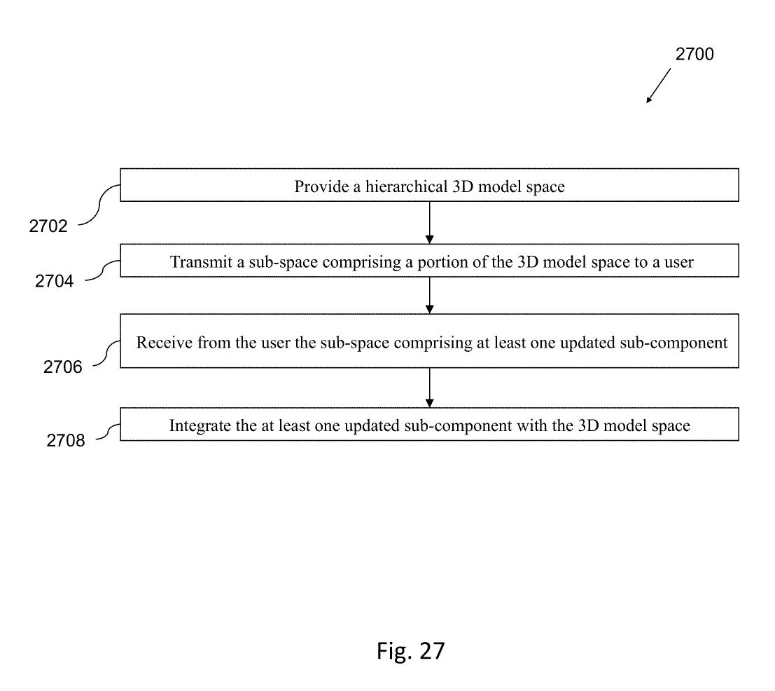

FIG. 27 depicts a flow chart of a method 2700 for integrating an updated sub-component with the 3D model space. At 2702, the method 2700 may provide a hierarchical 3D model space. The 3D model space may include a plurality of nodes and at least one branch. Each node may include at least one version of a sub-component. At 2704, the method 2700 may transmit a sub-space comprising a portion of the 3D model space to a user. At 2706, the method 2700 may receive from the user the sub-space that may include at least one updated sub-component. At 2708, the method 2700 may integrate the at least one updated sub-component with the 3D model space.

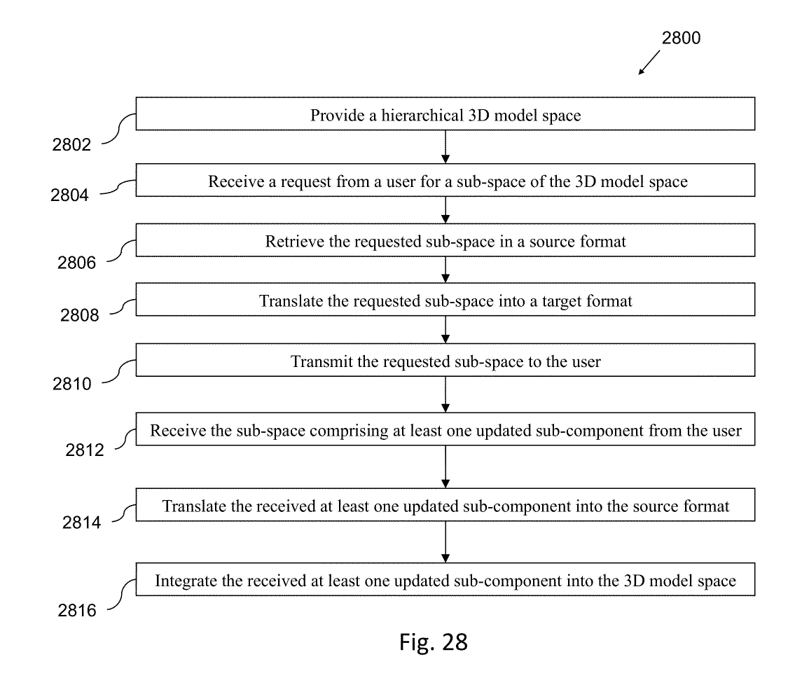

FIG. 28 depicts a flow chart of a method 2800 for transmitting a sub-space in a target format. At 2802, the method 2800 may provide a hierarchical 3D model space that may include a plurality of nodes and at least one branch. Each node may include at least one version of a sub-component. At 2804, the method 2800 may receive a request from a user for a sub-space of the 3D model space. At 2806, the method 2800 may retrieve the requested sub-space in a source format. At 2808, the method 2800 may translate the requested sub-space into a target format. At 2810, the method 2800 may transmit the requested sub-space to the user. Optionally, at 2812 and 2814, the method 2800 may receive the sub-space that may include at least one updated sub-component from the user and translate the received at least one updated sub-component into the source format. Optionally, at 2816, the method may integrate the received at least one updated sub-component into the 3D model space.

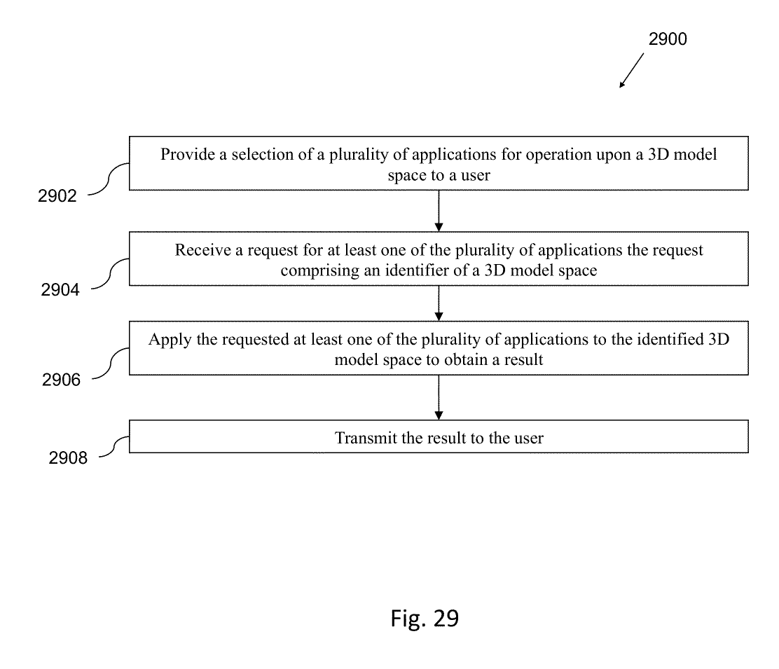

FIG. 29 depicts a flow chart of a method 2900 for processing a 3D model space using an application. At 2902, the method 2900 may provide a selection of a plurality of applications for operation upon a 3D model space to a user. At 2904, the method 2900 may receive a request for at least one of the plurality of applications the request comprising an identifier of a 3D model space. At 2906, the method 2900 may apply the requested at least one of the plurality of applications to the identified 3D model space to obtain a result. At 2908, the method 2900 may transmit the result to the user.

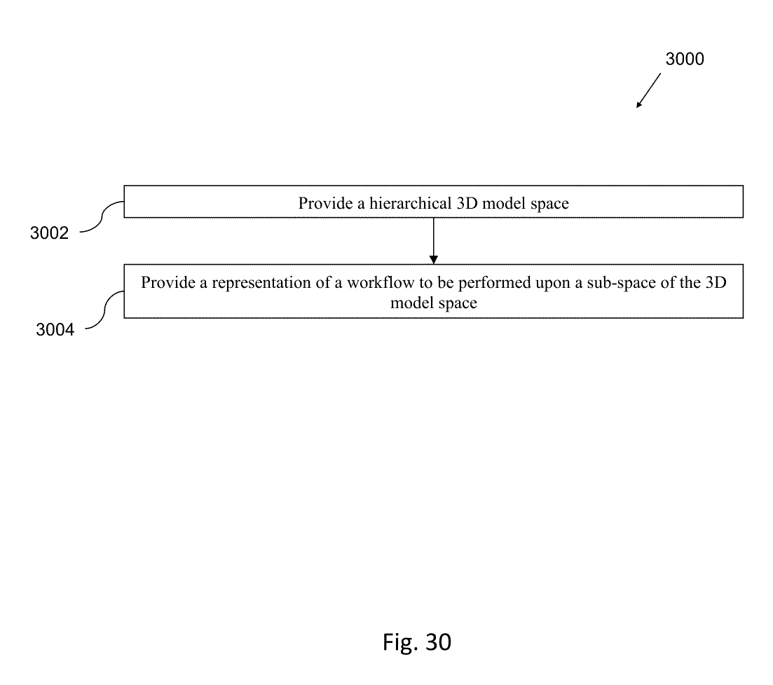

FIG. 30 depicts a flow chart for a method 3000 of a workflow for collaboration in a 3D shared modeling space. At 3002, the method 3000 may provide a hierarchical 3D model space that may include a plurality of nodes and at least one branch. Each node may include at least one version of a sub-component and each of the at least one version may include one or more attributes. At 3004, the method 3000 may provide a representation of a workflow to be performed upon a sub-space of the 3D model space.

A design platform 100 as discussed herein may find applications by users in various areas including, but not limited to Design Review and Presentation, Design Analysis and Optimization, Design Lifecycle Management, Modeling Tools for Content Creation, Algorithmic/Procedural 3D Content Generation, Knowledge Management/Decision Making, and Visualization.

Further, the design platform 100 may be used for Structural Optimization using Dynamic Relaxation, Life Cycle Analysis, Structural Optimization for Shape and Member Sizing, Streamlined Alternative Generation and Design Making, Textbook on Computation Design based on Sunglass platform, Bioclimatic Architecture, Urban Scale Agent Modeling, Intelligent Interfaces and Probabilistic Reasoning Driven Assembly in 3D Modeling.

Also the design platform 100 may enable users to combine paper/pencil and Sketchup/Rhino/Revit without accessing key simulation tools that may be only available later. Further, the platform may facilitate file exchange across tools. As mentioned herein, real-time collaboration may facilitate in increasing performance and reduction of design cycle time.

In addition, the design platform 100 may support content storage that facilitates collaboration, integration with existing CAD technologies, one-click access, and the like. Access to platform-related content may be enhanced by users exchanging unique links to the content, such as a link related to a recent change, particular design information, and the like. The stored content may be associated with a timeline that can be presented to a user so that a user can slide a pointer on the timeline back and forth to view the entire life-cycle of a design model. Content may be user/collaborator tagged so that users with appropriated privileges can see which collaborator made what changes to the drawing/model or part of the drawing/model at any part of the timeline. Access to the stored content (e.g. design model) may be accessed through a link (e.g. such as the unique links described above) that facilitates access to the entire scenario of model+simulations+timeline−significantly speeding up the delivery of a content to a general viewer without needing any platform-specific software installation except for a browser. In this way a non-platform user can be seamlessly invited to view content. Also, from design platform 100, users have the option to transport a snapshot of the model to a standard drawing format such as 3DS, OBJ, STL, Blend, DAE, SolidWorks, Autodesk Inventor, CATIA, Creo, I-deas, IGES/STEP, IFC, JT, Parasolid, PRC, Pro/Engineer, Siemens PLM/NX, Solid Edge, VDA-FS and VRML files, OBJ, STL, DXF etc.

The collaborative 3D design platform of the present disclosure may provide components for 3D modeling and/or a framework for simulation through third party offerings such as OpenCascade Technology, and the like. Through a robust application integration methodology, the platform of the present disclosure may provide advanced and robust software components for 3D modeling within a low-cost collaborative environment.

The platform of the present disclosure may facilitate a form of virtualization in that it may facilitate separating modeling data from visualization of that data so that a variety of visualization platforms (e.g. thin client or light OS devices such s tablets and the like) may be readily integrated into use scenarios. One aspect of virtualization that may facilitate visualizing data structures may rely on ready-to-use algorithms (such as those available from OpenCascade Technology and the like), which may create graphic presentations from geometric models. These algorithms may enable viewing a variety of geometric models through little more than a web browser with a plugin software module. Visualization (e.g. display) and 3D data selection may be managed through a type of presentation service and a type of selection service respectively. With these services, data structures representing any 3D model (e.g. a geometric model) and presentation algorithms may facilitate display and interactive selection of 3D objects through a web browser interface or the like.

Virtualization of model geometry from visualization algorithms may enable separation that may allow the user to modify a geometric or topological model without modifying the services by which it is displayed. Likewise, visualization algorithms may allow the selection of an object when a web browser user interface mouse/cursor is positioned over a visualization of the underlying geometric/3D model. The visualization algorithms describe herein may facilitate managing interactive context, interactive objects, graphic attributes, selection filters, and the like.

These visualization algorithms may support the 3D manipulation of graphic primitives such as polylines, planar polygons with or without holes, text, and markers by controlling attributes such as for example, color, transparency, reflection, line type, line width, text font, and the like. Operations may include being displayed, zoomed, panned, and rotated in a 3D viewer. Similarly, 2D graphic visualization support may include 2D manipulation of graphic primitives such as straight lines, segments, polylines, curves, text, and markers as noted for 3D items. These primitives can be displayed, zoomed, panned, and rotated in a 2D viewer.

The platform of the present disclosure may also facilitate data exchange (e.g. standardized) in a multi-software environment, thereby ensuring a good level of integration with existing 3D design and modeling tools. This may result in obtaining good quality over a wide range of exchange needs at a range of desired exchange quality levels including exchanged data between standards, such as Initial Graphics Exchange Specification (IGES) and Standard for the Exchange of Product model data (STEP) may include Read and Write 3D data as IGES format (5.3) and STEP format (AP203, AP214 and AP209).

In addition to support of exact geometrical representation of 3D objects, the technology of the platform described herein may provide functionality to work with tessellated representations of the objects, such as in the form of mesh. Mesh functionality may include supporting data structures to store surface mesh data associated with shapes, some basic algorithms to handle these data, data structures and algorithms to build surface triangular mesh representations of 3D objects, and tools to extend 3D visualization capabilities to mesh representation. The platform may support mesh formats such as Virtual Reality Modeling Language (e.g. VRML 1.0) and Stereo lithography (e.g. STL for rapid prototyping) in shaded or wireframe representations. A shaded representation may present shapes as sets of triangles computed by a mesh algorithm while a wireframe representation may present shapes as sets of curves.

The platform of the present disclosure may support modeling via a library of modeling algorithms that may support a range of topological algorithms commonly used in 3D modeling. This library of modeling algorithms may include third party modeling software, tools, and the like that may be useable to manipulate the 3D objects and/or provide results of various modeling actions. Geometric packages such as Geom3D and the like may provide STEP-compliant 3D geometric data structures as objects that may be parameterized and oriented. These objects may include Bezier, BSpline, offset curves, and surfaces, and provide functions for conversion of Geom3D objects to basic geometry objects, which may be non-oriented and non-parameterized.

In an embodiment, the 3D collaborative design and modeling platform that is described herein may include a version control system (VCS) that may be configured to facilitate quickly distributing management of version control of 3D design elements and sub-elements. The system described herein may provide a user interface that may allow one or more users to work on the same 3D design space, element, sub-element, sub-space, and the like to make changes while keeping track of those changes over time. Changes to an element, part, sub-element, and the like can also be undone, such as by selecting an alternate (e.g. earlier) version of a changed element. The VCS of the current platform may facilitate committing the state of a defined portion of a 3D design project to one or more users, thereby facilitating distributed version control in a collaborative 3D design environment. These users may share access to this committed state with other developers to collaborate and integrate their 3D design work with the other user efforts, and compare or revert to previous versions of the design, space, sub-space, element, sub-element, part, and the like.

The VCS may be centralized, partially distributed, and/or fully distributed, which means that it may work almost entirely offline. In an embodiment, the VCS may be configured to perform all of its operations without needing a network connection, including history viewing, difference viewing and committing, and the like. The VCS can support basic functions, such as: giving the user a way to rollback to a known state; facilitating version control when many users are simultaneously working on the same element and the like; user locking a space, sub-space, part, element, sub-element, and the like so that until the user releases the lock no one else can edit the locked item.

The VCS facilitates sophisticated branching and merging. Instead of the popular VCS branching method of simply cloning into a separate directory for a branch, the VCS of the present disclosure may let the user instantly switch between branches, including private branches that may not be shared to make it easy to stash partially completed work.

In an aspect, instead of only having branches for multi-component design changes, the VCS may be configured to routinely create, integrate, and destroy multiple branches on periodic intervals, based on events, or by user command. Often each part change or enhancement that the user is working on may have its own branch, integrated in only when it is complete. This model may allow the user to experiment quickly, easily and safely without having to go through hoops to get back to where the user is. Further, the system may be configured to enable a non-linear development cycle, where the user may work on multiple lines of thought in parallel without stepping them on each other.

In an aspect, one of the design goals of the VCS is the speed. The VCS described herein may be configured to use one or more optimized commands such as to perform the operation very fast. A protocol for communicating versions in the VCS may also be very efficient such as to quickly and easily figure out what data needs to be sent, including compressing and sending deltas or the like to version visualization user interfaces and the like. Further, the VCS may be configured to facilitate digging through components, nodes, sub-components, sub-spaces and the like breadth-first manner (meaning identify at least one version of each sub-components associated with a particular version of an upper level component).

In an aspect, the VCS described herein is distributed and disconnected. Coupled with the excellent branching and reintegration capabilities, this allows the user, for instance, to quickly create a branch for some experimental modeling that may or may not work, test things out, and either discard or reuse the changes later. In an example, if a user works offline often, there may be greater benefit to the user to be able to submit each changed part separately, including sending successive and/or different changes of a single part over time to be captured as separate versions of the part. Alternatively, a user may create, modify, test, and finalize several components (e.g. a portion of components accessible in a sub-space) and then submit the finalized several components at once and the VCS will determine a proper version mark and tracking for each submitted part. Generally, integrating each part change/or at least keeping integrating to a fine granularity may make design reviews easier and may facilitate isolating at which version a defect or incompatible change was made.

In an aspect, the VCS may automate version testing on behalf of the user. For example, suppose a user determines that a cost constraint for an upper level component assembly is not being met and several changes have been made recently. Because the 3D modeling platform is a multi-user collaborative environment, changes may be made at any time by any number of users. Therefore, determining which change(s) by which user(s) contribute to the cost overrun, may be difficult if performed manually. The VCS may review attributes (e.g. cost attributes) of each version of each component in a methodical way to identify which versions of which sub-parts may have introduced an increase in cost. The user may determine which identified versions should be retained and which should be removed to achieve the cost constraint parameter. As described herein, the user may establish business rules, preferences, and the like for automating the version selection process, including the version identification and selection process described here.

The methods and systems for multi-user on-line 3D design collaboration described herein may allow one or more users to present a user interface of the 3D modeling space including one or more sub-spaces, components, sub-components and the like as an integral visualization of a webpage using a Javascript based web graphics language, such as WebGL. By generating WebGL compatible Javascript and or via use of a WebGL API, the methods and systems described herein may allow a user to show a 3D design project via a conventional browser on any computer without needing any advanced and expensive web development. The system may be configured to use WebGL API such as to display 3D content with high quality. A WebGL compatible embodiment may be configured to provide features such as 3D visualization features, online editing, collaborative work on 3D models, and the like.

A tertiary objective of the methods and systems described herein may be to facilitate generating dynamic online 3D views via a web browser of third-party 3D modeling and design tools such as Solid Works, Pro Engineer, Siemens NX, CATIA, Autodesk inventor, IGES, STEP, Para solid, STL, 3D scan and the like to make these output of these tools available to collaborators in a fully distributed 3D environment. The format conversion capabilities described herein, such as those provided by the client interface 114 may facilitate rapid ingestion of model data from a third-party 3D design tool to an environment such as the 3D modeling space 400 described herein which can be immediately viewed in a web browser of any client device accessing the 3D model space 400. As described herein, the 3D model space 400 may be encoded, culled, and the like to efficiently present the 3D model space on any suitably enabled web browser.

The 3D model space user may have full access to the capabilities of the 3D space to take actions such as explode and/or hide assembly components, save views, take basic measurements, and the like. Further, through the 3D project collaboration capabilities described herein, users of third-party 3D modeling software may collaborate in near real-time with users of other third-party 3D modeling tools and with users of the 3D model space via a web browser or other interface suitable for a light client device (e.g. mobile, tablet, notebook, and the like). This may facilitate collaboration with non-technical co-workers, partners, VARs, clients, sales prospects, and the like without any complicated permission setups or third-party specific software installations.

Methods and systems of on-line collaborative 3D modeling may facilitate associating version control with accessibility of a 3D modeling space by diverse user systems. The 3D on-line collaborative modeling methods and systems described herein may provide version control management features, capabilities, and the like via user interfaces that support manual and attribute-based component version selection. These same 3D on-line collaborative modeling methods and systems may facilitate access to a 3D modeling space, including access to specific versions of components via the version control features described herein from diverse user systems such as mobile computers (mobile phone, smart phone), portable computers (laptop, notebook), and other computers (workstation, desktop, server, network appliance) and the like. Diverse user system access to the 3D modeling space and the version control features may be enabled by cross-device and cross-format capabilities provided by a user/client interface of a 3D modeling platform that provides content to user systems as needed and on demand in a format that is suitable for rendering on the user system. In this way a user of a mobile phone may view a version selection user interface for manually selecting a version of a sub-component to be included in a component that a user of a laptop computer is editing via a web browser based 3D editing capability provided by the platform.

Methods and systems of on-line collaborative 3D modeling may facilitate associating version control with definition and use of sub-spaces and hierarchy of a 3D model space. The 3D on-line collaborative modeling methods and systems described herein may provide version control management features, capabilities, and the like via user interfaces that support manual and attribute-based component version selection. These same 3D on-line collaborative modeling methods and systems may facilitate definition and use of sub-spaces and hierarchy of a 3D model space. Defining a 3D model space via sub-spaces and hierarchies of sub-spaces or sub-components allows for fine grained control of access to elements in a 3D design project. Collaboration among users may also be facilitated by providing multiple users access rights for a sub-space and those users may further define that sub-space into additional sub-spaces and/or hierarchies. The version control features and capabilities described herein maybe applied at the 3D model level, sub-space level, sub-divided sub-space level, component hierarchy level, and the like. When version control features and sub-space capabilities are combined, distribution of version control management may be achieved by allowing an owner of a sub-space to define or impose a version control management methodology that is specific to the owner's sub-space. In this way, an owner of a sub-space may control which versions of components within the sub-space are accessible for use in a component or assembly of components in the 3D model space that contains the sub-space.

Methods and systems of on-line collaborative 3D modeling may facilitate associating version control with democratized access to 3D related applications via a 3D modeling space. The 3D on-line collaborative modeling methods and systems described herein may provide version control management features, capabilities, and the like via user interfaces that support manual and attribute-based component version selection. These same 3D on-line collaborative modeling methods and systems may facilitate democratized access to modeling related applications via a 3D modeling space. Accessing modeling related applications via a 3D modeling space may be done on a shared basis, such as a pay-per-use basis, so that not only can a user of a light weight device (e.g. a tablet) have access to computation intensive modeling analysis functions, but the results of the use of such applications can be maintained within an on-line collaborative 3D model space. In an example of combining version control with application access, a user may identify a specific version of a component in the 3D model space and may apply an application that analyzes certain features of the component and makes changes to those features to conform to a standard (e.g. converting screw threads from U.S. to metric). The automatically changed component may be presented to the user who may save it as a different version. Information about the changed component that may be stored in metadata or attributes associated with the different version may include details of the change process including that the process was automatically performed by an application that was accessed via the 3D model space, and the like.

Methods and systems of on-line collaborative 3D modeling may facilitate associating version control with expert collaboration workflows of a 3D model space. The 3D on-line collaborative modeling methods and systems described herein may provide version control management features, capabilities, and the like via user interfaces that support manual and attribute-based component version selection. These same 3D on-line collaborative modeling methods and systems may facilitate expert collaboration workflows of a 3D model space. Expert collaboration on a 3D modeling project may be facilitated by a 3D on-line collaboration modeling platform as described herein via an expert collaboration portal that may guide a user to select and interact with a subject matter expert. Likewise, expert collaboration may be part of a 3D design workflow that can be automated by the 3D model platform. In an example of combining version control with expert collaboration workflow, a user may define a workflow that includes a step of design review by an expert when a user makes changes to a component. The user may save the changed component as a new version of the component and the workflow may inform the expert of the need for review of the new version. Upon completion of the expert review, metadata associated with the new version of the component may be automatically updated to indicate that the review has been conducted and may include the results of the expert review. In this way, a subject matter expert may be collaborating with 3D designers in a seamless workflow.

Methods and systems of on-line collaborative 3D modeling may facilitate associating accessibility of a 3D modeling space by diverse user systems with definition and use of sub-spaces and hierarchy of a 3D model space. The 3D on-line collaborative modeling methods and systems described herein may provide 3D model space accessibility to diverse user systems including access from diverse user systems such as mobile computers (mobile phone, smart phone), portable computers (laptop, notebook), and other computers (workstation, desktop, server, network appliance) and the like. These same 3D on-line collaborative modeling methods and systems may facilitate definition and use of sub-spaces and hierarchy of a 3D model space. Defining a 3D model space via sub-spaces and hierarchies of sub-spaces or sub-components allows for fine grained control of access to elements in a 3D design project. Collaboration among users may also be facilitated by providing multiple users access rights for a sub-space and those users may further define that sub-space into additional sub-spaces and/or hierarchies. Combining the 3D model space access features that support diverse user systems with use of sub-spaces and/or hierarchy of a 3D model space, may facilitate seamless integration of components and/or sub-components that are created and/or maintained by a diversity of user systems within a plurality of sub-spaces into a modeling hierarchy that is user device agnostic. Therefore, any part in any sub-space can be part of a 3D design hierarchy while being accessed or maintained by any of the diverse user systems (e.g. tablet, notebook, server, and the like).

Methods and systems of on-line collaborative 3D modeling may facilitate associating accessibility of a 3D modeling space by diverse user systems with democratized access to 3D related applications via a 3D modeling space. The 3D on-line collaborative modeling methods and systems described herein may provide 3D model space accessibility to diverse user systems including access from diverse user systems such as mobile computers (mobile phone, smart phone), portable computers (laptop, notebook), and other computers (workstation, desktop, server, network appliance) and the like. These same 3D on-line collaborative modeling methods and systems may facilitate democratized access to modeling related applications via a 3D modeling space. Accessing modeling related applications via a 3D modeling space may be done on a shared basis, such as a pay-per-use basis, so that a user can access any such application (e.g. a computation intensive modeling analysis or simulation function) from any type of user device. In this way a tablet user may simulate a complex mechanical function and view the function in near real-time on the tablet.

Methods and systems of on-line collaborative 3D modeling may facilitate associating accessibility of a 3D modeling space by diverse user systems with expert collaboration workflows of a 3D model space. The 3D on-line collaborative modeling methods and systems described herein may provide 3D model space accessibility to diverse user systems including access from diverse user systems such as mobile computers (mobile phone, smart phone), portable computers (laptop, notebook), and other computers (workstation, desktop, server, network appliance) and the like. These same 3D on-line collaborative modeling methods and systems may facilitate expert collaboration workflows of a 3D model space. Expert collaboration on a 3D modeling project may be facilitated by a 3D on-line collaboration modeling platform as described herein via an expert collaboration portal that may guide a user to select and interact with a subject matter expert. Likewise, expert collaboration may be part of a 3D design workflow that can be automated by the 3D model platform. Diverse user system support may enable a subject matter expert to view, analyze, and make modification to a 3D component in the 3D model space that was created by a user on a powerful third-party workstation level 3D design tool without needing access to the same powerful workstation 3D design tool. In this way the subject matter expert may provide specific guidance that can be integrated by the user quickly and seamlessly.

Methods and systems of on-line collaborative 3D modeling may facilitate associating definition and use of sub-spaces and hierarchy of a 3D model space with democratized access to 3D related applications via a 3D modeling space. The 3D on-line collaborative modeling methods and systems described herein may provide definition and use of sub-spaces and hierarchy of a 3D model space. Defining a 3D model space via sub-spaces and hierarchies of sub-spaces or sub-components allows for fine grained control of access to elements in a 3D design project. Collaboration among users may also be facilitated by providing multiple users access rights for a sub-space and those users may further define that sub-space into additional sub-spaces and/or hierarchies. These same 3D on-line collaborative modeling methods and systems may facilitate democratized access to modeling related applications via a 3D modeling space. Accessing modeling related applications via a 3D modeling space may be done on a shared basis, such as a pay-per-use basis, so that a user can access any such application (e.g. a computation intensive modeling analysis or simulation function) from any type of user device. Definition of sub-spaces may be combined with modeling and/or simulation application access to enable targeting of applications by sub-space. In an example, a 3D model space may include an automated sprinkler controller assembly. A first sub-space may includes water pumps and a second sub-space may include electronic console components. Applications, such as fluid dynamics analysis functions may be targeted to a user accessing the 3D model space via the first sub-space while sunlight visibility analysis functions may be targeted to a user accessing the 3D model space via the second sub-space. While all applications may be available to each user, the targeted applications may be disposed in an application store user interface differently to the two users. Techniques such as highlighting, ordering, grouping, and the like may be used to present the same selection of applications to the two users differently based at least in part on information retrieved from the user specific sub-space.

Methods and systems of on-line collaborative 3D modeling may facilitate associating definition and use of sub-spaces and hierarchy of a 3D model space with expert collaboration workflows of a 3D model space. The 3D on-line collaborative modeling methods and systems described herein may provide definition and use of sub-spaces and hierarchy of a 3D model space. Defining a 3D model space via sub-spaces and hierarchies of sub-spaces or sub-components allows for fine grained control of access to elements in a 3D design project. Collaboration among users may also be facilitated by providing multiple users access rights for a sub-space and those users may further define that sub-space into additional sub-spaces and/or hierarchies. These same 3D on-line collaborative modeling methods and systems may facilitate expert collaboration workflows of a 3D model space. Expert collaboration on a 3D modeling project may be facilitated by a 3D on-line collaboration modeling platform as described herein via an expert collaboration portal that may guide a user to select and interact with a subject matter expert. Likewise, expert collaboration may be part of a 3D design workflow that can be automated by the 3D model platform. In an example of combining sub-space use with expert collaborative workflow functionality, a user may define a workflow for a 3D model space that includes a first collaboration action with a subject matter expert, such as review of final assembly. The workflow may further identify a second collaboration action with the subject matter expert for assembly of components accessible in a sub-space. For the first collaboration action, the subject matter expert may be given access to the entire 3D model space without access to modify the space. However, for the second collaboration action, the subject matter expert may be provided access to modify components in the sub-space to enact assembly improvement changes to the parts. In this way, a single subject matter expert may be invited to collaborate on a 3D design with very different access rights based on the space/sub-space in which the collaboration is taking place.

Methods and systems of on-line collaborative 3D modeling may facilitate associating democratized access to 3D related applications via a 3D modeling space with expert collaboration workflows of a 3D model space. Accessing modeling related applications via a 3D modeling space may be done on a shared basis, such as a pay-per-use basis, so that a user can access any such application (e.g. a computation intensive modeling analysis or simulation function) from any type of user device. These same 3D on-line collaborative modeling methods and systems may facilitate expert collaboration workflows of a 3D model space. Expert collaboration on a 3D modeling project may be facilitated by a 3D on-line collaboration modeling platform as described herein via an expert collaboration portal that may guide a user to select and interact with a subject matter expert. Likewise, expert collaboration may be part of a 3D design workflow that can be automated by the 3D model platform. Combining democratized access to applications with subject matter expert collaboration may enable access to subject matter experts who do not independently have access to sophisticated modeling or simulation applications. Likewise, users can provide subject matter experts with access to computation intensive applications like 3D functional simulation without burdening the expert with being equipped with costly workstation class equipment. While subject matter experts may have access to such systems, cross functional issues may make it challenging for the expert and user to collaborate in real-time. Access to these applications via a shared on-line collaboration 3D model space platform may provide a highly efficient and productive expert collaboration environment. The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1-48. (canceled)

49. A method comprising;
providing a hierarchical 3D model space comprising a plurality of nodes and at least one branch wherein each node comprises a plurality of versions of a sub-component and wherein each of the plurality of versions comprises one or more component attributes;
receiving in an automated version selection facility a sub-component selection criteria;
comparing at least one of the one or more component attributes for each of the plurality of versions of the sub-component to determine at least one version of the plurality of versions that satisfies the sub-component selection criteria; and
configuring the hierarchical 3D model space with at least one of the versions that satisfies the sub-component selection criteria.

50. The method of claim 49, wherein the 3D model space is accessible by multiple users over a network.

51. The method of claim 50, wherein the network is the Internet.

52. (canceled)

53. A method comprising:
providing a hierarchical 3D model space comprising a plurality of nodes and at least one branch wherein each node comprises at least one version of a sub-component and wherein each of the at least one version comprises one or more attributes;
receiving from a user a selection of at least one attribute identifier;
selecting a version of a sub-component based, at least in part, upon the at least one attribute identifier; and
in response to the selecting one of the at least one version of the sub-component, rendering the sub-component identified by the selected one of the version of the sub-component in the 3D model space.

54. The method of claim 53 further comprising:
determining if the selected sub-component is compatible with other sub-components in the 3D model space; and
if the selected sub-component is not compatible with other sub-components in the 3D model space, presenting an error indicator to the user.

55. The method of claim 53, wherein the 3D model space is accessible by multiple users over a network.

56. The method of claim 55, wherein the network is the Internet.

57. The method of claim 53, wherein each version of a sub-component is accessible in a library associated with the 3D model space

58. The method of claim 53, wherein the at least one attribute identifier is a fit criteria.

59. The method of claim 58, wherein the fit criteria is a price of the sub-component.

60. The method of claim 58, wherein the fit criteria is a price of an assembly comprising the sub-component.

61. The method of claim 58, wherein the fit criteria is determined from a business rule associated with the 3D model space.

62. The method of claim 53, wherein the at least one attribute identifier is a performance criteria.

63. The method of claim 62, wherein the performance criteria is a measure of strength of the sub-component.

64. The method of claim 62, wherein the performance criteria is a measure of stress/strain tolerance of the sub-component.

65. The method of claim 62, wherein the performance criteria is a measure of weight of the sub-component.

66. The method of claim 62, wherein the performance criteria is an aspect of material properties of the sub-component.

67. The method of claim 62, wherein the performance criteria is based on compatibility of the sub-component with other sub-components in the 3D model space.

68. The method of claim 53, wherein the at least one attribute identifier identifies a compatibility of the sub-component with mating sub-components in the 3D model space.

69. The method of claim 68, wherein the compatibility comprises geometric compatibility.

70-299. (canceled)
